(19) United States
(12) Patent Application Publication
(10) Pub. No.: US 2024/0406589 A1
(43) Pub. Date: Dec. 5, 2024

(54) IMAGE PIXEL SUPPORTING GLOBAL SHUTTER AND ROLLING SHUTTER, IMAGE SENSOR INCLUDING THE SAME, AND OPERATING METHOD OF IMAGE SENSOR

(71) Applicant: Samsung Electronics Co., Ltd., Suwon-si (KR)

(72) Inventor: JAEKYU LEE, Suwon-si (KR)

(21) Appl. No.: 18/668,369

(22) Filed: May 20, 2024

(30) Foreign Application Priority Data
Jun. 1, 2023 (KR) 10-2023-0070896
Aug. 16, 2023 (KR) 10-2023-0107260

(51) Int. Cl. H04N 25/532; H04N 25/531; H04N 25/59; H04N 25/771

(52) U.S. Cl. CPC H04N 25/532; H04N 25/531; H04N 25/59; H04N 25/771

(57) ABSTRACT

Provided are an image pixel configured to selectively operate in a global shutter mode and a rolling shutter mode. An image pixel according to an embodiment of the present disclosure includes a photoelectric conversion element, a common circuit that includes a floating diffusion node configured to receive charges from the photoelectric conversion element and configured to transfer an output voltage to a first node based on a voltage of the floating diffusion node, a sampling circuit that includes a first capacitor and a second capacitor configured to store the output voltage of the first node, and a first transistor that electrically connects at least one of the first or second capacitors to the floating diffusion node.

### CROSS-REFERENCE TO RELATED APPLICATIONS

This application claims priority under 35 U.S.C. § 119 to Korean Patent Application Nos. 10-2023-0070896 filed on Jun. 1, 2023, and 10-2023-0107260 filed on Aug. 16, 2023, in the Korean Intellectual Property Office, the disclosures of which are incorporated herein by reference in their entireties.

### BACKGROUND

Embodiments of the present disclosure described herein relate to an image pixel and an image sensor including the same, and more particularly, relate to an image pixel configured to selectively operate in a global shutter mode or a rolling shutter mode, an image sensor including the same, and an operating method of the image sensor.

An image sensor includes devices that sense light from a subject to be converted to an electrical image signal. The image sensor includes a pixel array that includes a plurality of pixels arranged in the shape of a matrix. Each of the pixels of the pixel array may include at least one photoelectric conversion element that generates an electrical signal based on light received during an exposure time. The image sensor operates based on a global shutter operating method and/or a rolling shutter operating method. According to the global shutter operating method, a plurality of pixels of a pixel array are exposed from the same exposure start point during the same exposure time, and image signals are read out from the plurality of pixels by sequentially selecting a plurality of rows of the pixel array. According to the rolling shutter operating method, to obtain an image signal, the exposure and readout operations are performed whenever each of the plurality of rows of the pixel array is selected (or the exposure and readout operations are performed for each row of the pixel array sequentially).

### SUMMARY

Embodiments of the present disclosure provide an image pixel that may be configured to selectively operate in a global shutter mode or a rolling shutter mode and may be further configured to generate an image signal of a high dynamic range, an image sensor including the same, and an operating method of the image sensor.

According to an embodiment, an image pixel may include a photoelectric conversion element, a common circuit that includes a floating diffusion node configured to receive charges from the photoelectric conversion element and configured to transfer an output voltage to a first node based on a voltage of the floating diffusion node, a sampling circuit that includes a first capacitor and a second capacitor configured to store the output voltage of the first node, and a first transistor that is configured to electrically connect at least one of the first or second capacitors to the floating diffusion node. When the image pixel operates in a global shutter mode, a reset voltage may be stored in the first capacitor, and an image voltage may be stored in the second capacitor. When the image pixel operates in a rolling shutter mode, charges that overflow from the photoelectric conversion element may be stored in the first capacitor through the first transistor.

According to an embodiment, an image pixel may include a first photodiode, a common circuit that includes a first transfer transistor configured to transfer charges generated by the first photodiode to a first floating diffusion node, a reset transistor and a conversion gain transistor electrically connected in series between a pixel voltage and the first floating diffusion node and sharing a second floating diffusion node, and a drive transistor configured to generate an output voltage at a first node in response to a voltage of the first floating diffusion node, a sampling circuit that includes a first capacitor and a second capacitor storing the output voltage of the first node, and a first transistor that is configured to electrically connect at least one of the first or second capacitors to the second floating diffusion node. When the image pixel operates in a rolling shutter mode, charges that overflow from the first photodiode may be stored in the first capacitor through the conversion gain transistor and the first transistor. Also, the image pixel may further include a second photodiode and a third capacitor. When the image pixel operates in a global shutter operation, charges generated by one of the first photodiode or the second photodiode may be stored in the third capacitor.

According to an embodiment, an image sensor may include a pixel array in which a plurality of image pixels are arranged, and a mode setting register that sets an operating mode of the image sensor including the pixel array. Each of the plurality of image pixels may include a photodiode, a common circuit that includes a floating diffusion node configured to receive charges from the photodiode and transfers an output voltage of a first node based on a voltage of the floating diffusion node, a first transistor that is electrically connected between the first node and a column line, a sampling circuit that includes a second transistor electrically connected between the first node and a second node, a first capacitor, and a second capacitor, the first and second capacitors being electrically connected to the second node, a third transistor that is electrically connected between the second node and the column line, and a fourth transistor configured to electrically connect the floating diffusion node and the first capacitor. When the operating mode is a rolling shutter mode, charges that overflow from the photodiode may be stored in the first capacitor through the fourth transistor.

According to an embodiment, in an operating method of an image sensor, which includes a plurality of image pixels each including a photodiode, a floating diffusion node, a first capacitor, and a second capacitor, when the image sensor operates in a global shutter mode, a reset voltage corresponding to a reset state of the floating diffusion node may be stored in the first capacitor, and an image voltage, which corresponds to a state where charges accumulated by the photodiode are transferred to the floating diffusion node, may be stored in the second capacitor. When the image sensor operates in a rolling shutter mode, charges that overflow from the photodiode may be stored in the first capacitor.

According to an embodiment, in operating method of an image sensor, which includes a plurality of pixels each including a first photodiode, a second photodiode, a floating diffusion node, a first capacitor, a second capacitor, and a third capacitor, when the image sensor operates in a global shutter mode, a reset voltage corresponding to a reset state of the floating diffusion node may be stored in the first capacitor, an image voltage, which corresponds to a first state where charges accumulated by the first and second photodiodes are transferred to the floating diffusion node, may be stored in the second capacitor, and a signal, which corresponds to a second state where charges accumulated by one of the first photodiode or the second photodiode are transferred to the floating diffusion node, may be stored in the third capacitor. When the image sensor operates in a rolling shutter mode, charges that overflow from the first and second photodiodes may be stored in the third capacitor.

### BRIEF DESCRIPTION OF THE FIGURES

The above and other objects and features of the present disclosure will become apparent by describing in detail embodiments thereof with reference to the accompanying drawings.

FIG. 1 is a block diagram of an image sensor according to an embodiment of the present disclosure.

FIG. 2 is a schematic diagram of an image sensor of a stacked structure, according to an embodiment of the present disclosure.

FIG. 3 is a block diagram of an image pixel according to an embodiment of the present disclosure.

FIG. 4 is a circuit diagram of an image pixel according to an embodiment of the present disclosure.

FIG. 5 is a timing diagram that illustrates an operation of an image pixel of FIG. 4 in an RS mode.

FIG. 6 is a timing diagram that illustrates an operation of an image pixel of FIG. 4 in a GS mode.

FIG. 7 is a circuit diagram of an image pixel according to an embodiment of the present disclosure.

FIG. 8 is a circuit diagram of an image pixel according to an embodiment of the present disclosure.

FIG. 9 is a timing diagram that illustrates an operation of an image pixel of FIG. 8 in an RS mode.

FIG. 10 is a timing diagram that illustrates an operation of an image pixel of FIG. 8 in a GS mode.

FIG. 11 is a circuit diagram of an image pixel according to an embodiment of the present disclosure.

FIG. 12 illustrates an example of relative timing between sampling control signals of an image sensor of FIG. 11.

FIG. 13 is a circuit diagram of an image pixel according to an embodiment of the present disclosure.

FIG. 14 is a timing diagram that illustrates an operation of an image pixel of FIG. 13 in an RS mode.

FIG. 15 is a timing diagram that illustrates an operation of an image pixel of FIG. 13 in a GS mode.

FIG. 16 is a circuit diagram of an image pixel according to an embodiment of the present disclosure.

FIG. 17 is a circuit diagram of an image pixel according to an embodiment of the present disclosure.

FIG. 18 is a circuit diagram of an image pixel according to an embodiment of the present disclosure.

FIG. 19 is a timing diagram that illustrates an operation of an image pixel of FIG. 18 in a GS mode.

FIG. 20 is a block diagram illustrating an electronic device in which an image sensor including image pixels according to embodiments of the present disclosure is included.

### DETAILED DESCRIPTION

Because embodiments according to the inventive concept disclosed in the specification can make various changes and can have various forms, the embodiments are illustrated in drawings and are described in detail in the specification. However, there is no intent to limit the embodiments according to the inventive concept to particular forms disclosed, and the embodiments cover all modifications, equivalents, and alternatives falling within the spirit and scope of the invention. Like reference numerals in the drawings denote like elements, and thus their description will be omitted. As used herein, the term “and/or” includes any and all combinations of one or more of the associated listed items. It is noted that aspects described with respect to one embodiment may be incorporated in different embodiments although not specifically described relative thereto. That is, all embodiments and/or features of any embodiments can be combined in any way and/or combination.

The term “first” or “second” may be used to describe various elements/components, but the elements/components should not be limited by the term. The above terms may be named only for the purpose of distinguishing one element from another, for example, without limiting the embodiments according to the inventive concept. A first element may be referred to as a “second element”, and similarly a second element may also be referred to as a “first component”.

It should be understood that when any element is referred to as being “connected” or “coupled” to any other element, it can be directly connected or coupled to the other element or intervening elements may be present therebetween. In contrast, when it is mentioned that any element is “directly connected” or “directly coupled” to another element, it should be understood that any other element(s) are absent therebetween. Other expressions, which describe relationships between components, such as “between ˜”, “immediately between ˜”, “adjacent to ˜”, and “directly adjacent to” can be interpreted similarly.

The terms used herein to describe a specific embodiment are not intended to limit the invention. The articles “a”, “an”, and “the” are singular in that they have a single referent, but the use of the singular form in the specification should not preclude the presence of more than one referent. In the specification, the terms “include”, “comprise”, and “have” are intended to designate that feature, number, step, operation, component, part, or combination thereof described herein exists, but should be understood that it does not preclude the possibility of the presence or addition of numbers, steps, operations, components, parts, or combinations thereof.

Below, embodiments of the present disclosure will be described in detail with reference to accompanying drawings.

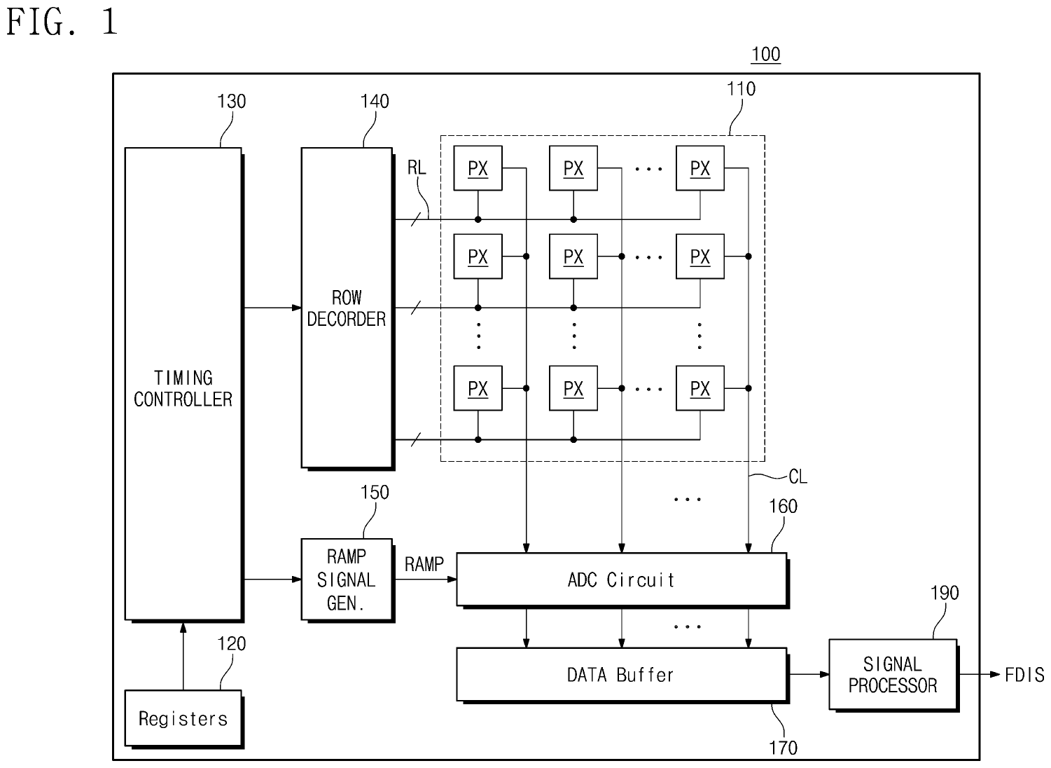

FIG. 1 is a block diagram of an image sensor according to an embodiment of the present disclosure.

An image sensor 100 may be installed in an electronic device with an image or light sensing function. For example, the image sensor 100 may be installed in an electronic device, such as a camera, a smartphone, a wearable device, an Internet of Things (IoT) device, home appliances, a tablet personal computer (PC), a personal digital assistant (PDA), a portable multimedia player (PMP), a navigation system, a drone, an advanced driver assistance system (ADAS), etc. Also, the image sensor 100 may be installed in an electronic device that is provided as a part of a vehicle, furniture, manufacturing equipment, a door, and various kinds of measuring instruments.

The image sensor 100 may include a pixel array 110, a mode setting register 120, a timing controller 130, a row driver 140, a ramp signal generator 150, an analog-to-digital converter (ADC) Circuit 160, a data buffer 170, and a signal processor 190.

The pixel array 110 includes a plurality of image pixels PX that are connected to a plurality of row lines RL and a plurality of column lines CL and are arranged in a matrix with rows and columns. Each image pixel PX may include at least one photodiode being a photoelectric conversion element and may be implemented in various structures capable of generating an electrical signal corresponding to a received light event. The image pixel PX may selectively operate in a rolling shutter mode (hereinafter referred to as an “RS mode”) or a global shutter mode (hereinafter referred to as a “GS mode”).

In an embodiment, the first image pixel PX may include a first capacitor and a second capacitor. When the first image pixel PX operates in the GS mode, the first image pixel PX may store reset information in the first capacitor and may store image information in the second capacitor. When the first image pixel PX operates in the RS mode, the first image pixel PX may store charges that overflow from the photodiode during an exposure time in at least one of the at least two capacitors, for example, in the first capacitor, which are used to generate an image signal. When the image sensor 100 including the first image pixel PX operates in the RS mode, the image sensor 100 may store charges that overflow from the photodiode exposed to a strong light event in a capacitor that is used in the GS mode. In this case, an image signal may be obtained even in a high-illuminance environment, and thus, an image of a high dynamic range may be generated.

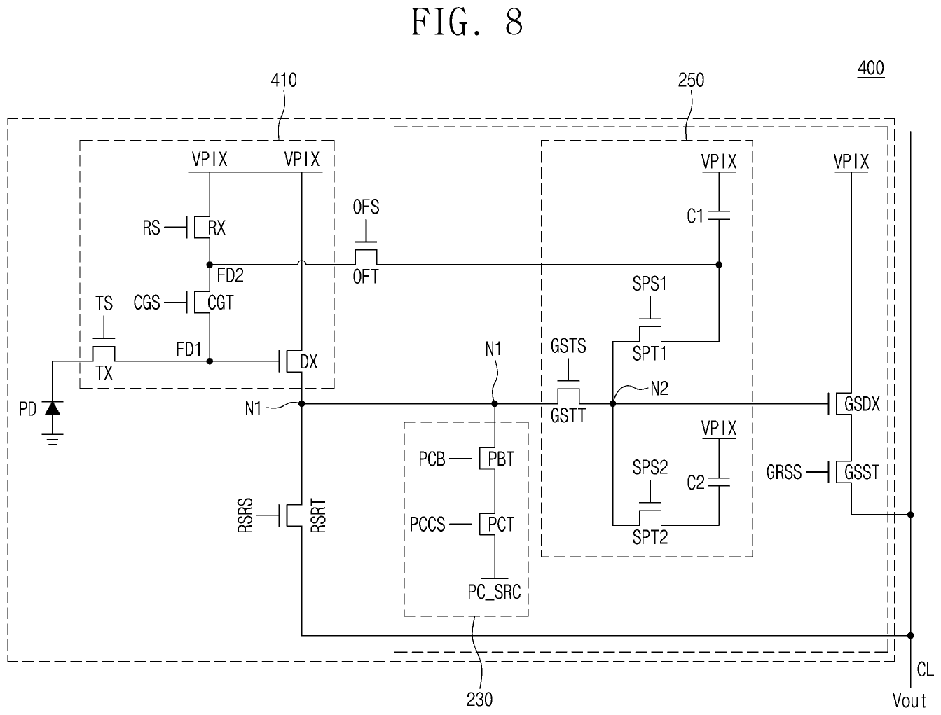

In another embodiment, the second image pixel PX may further include a conversion gain transistor (CGT) (refer to FIG. 8) that adjusts a conversion gain in the first image pixel PX. In the RS mode, the image sensor 100 including the second image pixels may generate an image signal by using the overflow charges of the photodiode stored in the first capacitor and may also generate image signals by performing conversion with respect to the charges accumulated by the photodiode by using the conversion gain transistor, such that two different conversion gains are applied. As such, an image of a higher dynamic range may be generated. In addition, even when the image sensor 100 including the second image pixels operates in the GS mode, the image sensor 100 may control the conversion gain transistor depending on an ambient environment, such that an image signal is generated based on a gain selected from two different conversion gains.

In another embodiment, the third image pixel PX may further include a photodiode capable of generating autofocus (AF) information in the second image pixel and may further include a third capacitor that stores a signal associated with the AF information. When the third image pixel PX operates in the GS mode, the third image pixel PX may store reset information in the first capacitor, may store image information corresponding to a sum of charges generated by two photodiodes in the second capacitor, and may store information corresponding to the charges accumulated by one photodiode among the two photodiodes in the third capacitor. The image sensor 100 including the third image pixels may generate the AF information in both the RS mode and the GS mode; in the RS mode, the image sensor 100 including the third image pixels may also generate an image signal of a high dynamic range by using at least one of the capacitors used in the GS mode.

In another embodiment, the fourth image pixel PX may further include a fourth capacitor and a fifth capacitor in addition to the structure of the third image pixel. When the image sensor 100 including the fourth image pixel PX operates in the RS mode or the GS mode, in both the RS mode and the GS mode, the image sensor 100 may generate image signals together with the AF information based on charges generated by photodiodes, such that at least two different conversion gains are applied. Accordingly, an image signal of a high dynamic range may be obtained.

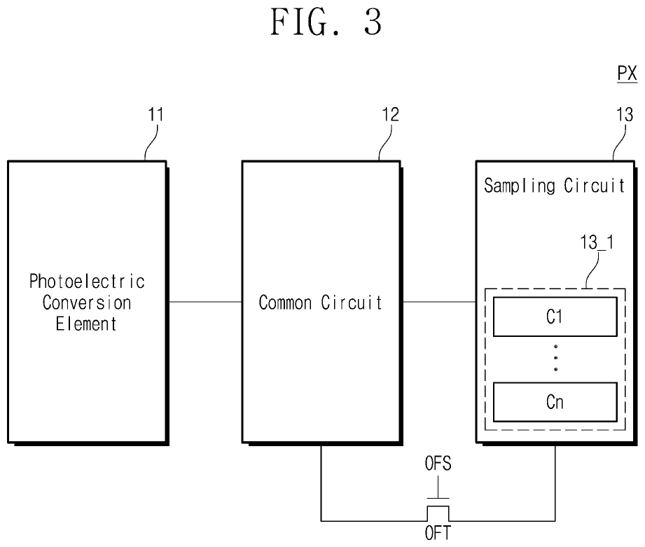

Below, circuit diagrams and operations of the image pixels PX, according to embodiments of the present disclosure, will be described in detail with reference to FIG. 3.

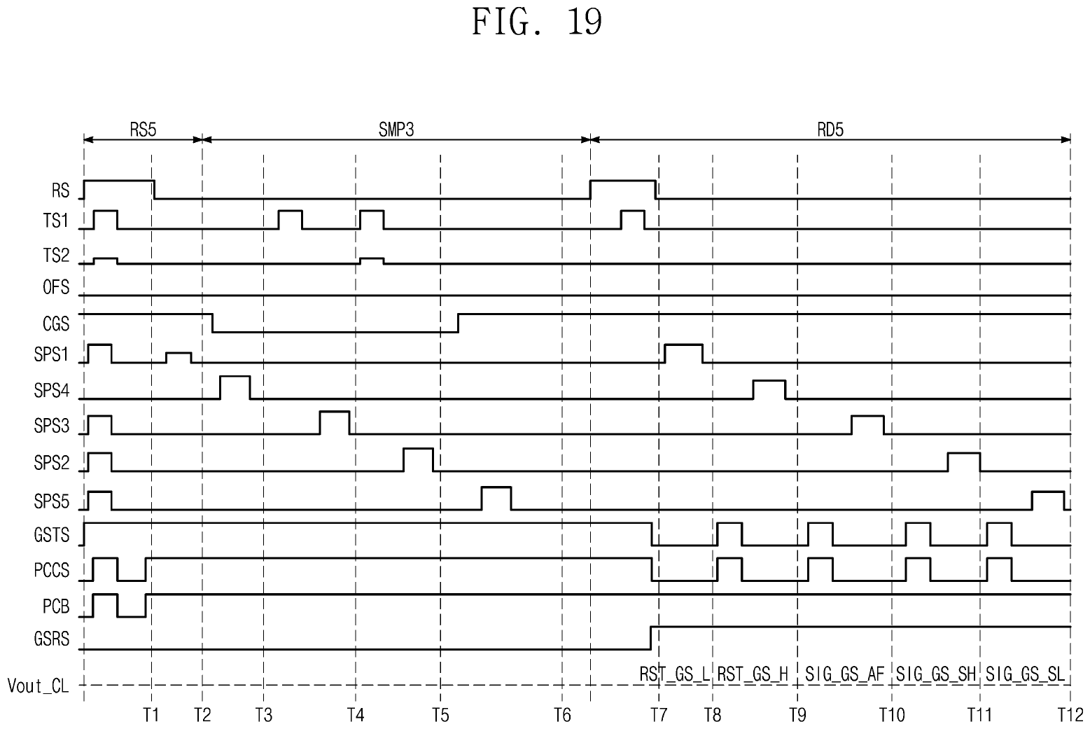

The mode setting register 120 may store information about an operating mode of the image pixel PX included in the pixel array 110 of the image sensor 100. The information about the operating mode may be stored in the mode setting register 120 of the image sensor 100 through a given interface with an external application processor (refer to FIG. 19). The image sensor 100 may transmit an image signal FDIS, which is generated based on the operating mode information stored in the mode setting register 120, to the application processor. The operating mode of the image sensor 100 may include the GS mode or the RS mode and may be set to adjust a conversion gain for each operating mode.

The timing controller 130 may control various blocks included in the image sensor 100 based on the operating mode information stored in the mode setting register 120.

The row driver 140 may generate pixel control signals for driving the image pixels PX of the pixel array 110 based on control signals from the timing controller 130. In the RS mode, the row driver 140 may generate the pixel control signals, such that the image pixels PX of the pixel array 110 are exposed for each row (or in units of row) to generate image signals. In the GS mode, the row driver 140 may generate the pixel control signals such that the image pixels PX connected to the plurality of rows of the pixel array 110 are simultaneously exposed to a light event and image signals are generated for each row (or in units of row).

The ramp signal generator 150 may generate a ramp signal (e.g., a ramp voltage) RAMP whose level increases or decreases at a given slope under control of the timing controller 130. The ramp signal RAMP may be provided to each of a plurality of comparators (not illustrated) included in the ADC Circuit 160.

The ADC Circuit 160 may include correlated double sampling (CDS) circuits that are respectively connected to the column lines CL, and each of the CDS circuits may include a comparator and a counter. Each CDS circuit may compare the ramp signal RAMP with each of a reset voltage and an image voltage transferred through the corresponding column line CL. Each CDS circuit may count a result of the comparison and may generate a digital image signal corresponding to a result of the counting.

The data buffer 170 may receive the digital image signals from the ADC Circuit 160. The data buffer 170 may include a memory that temporarily stores the received digital image signals and a memory controller that aligns the digital image signals stored in the memory to be output to the signal processor 190.

The signal processor 190 may receive the aligned digital image signals from the data buffer 170. The signal processor 190 may process the received digital image signals to generate the final digital image signal FDIS. The signal processor 190 may further perform one or more of the following signal processing operations with respect to the received digital image signals: noise reduction processing, gain adjustment, waveform shaping processing, interpolation processing, white balancing processing, gamma processing, edge enhancement processing, and/or binning. Meanwhile, according to an embodiment, some of the signal processing functions of the signal processor 190 may be performed by an external processor of the image sensor 100.

As described above, the image sensor 100 according to the present disclosure may selectively operate in the GS mode or the RS mode depending on how the operating mode is set. In an embodiment, the image sensor 100 may operate in the GS mode to photograph a fast video and may operate in the RS mode to photograph a high-definition still image or a slow video. In an embodiment, the image sensor 100 may operate in the RS mode in the high-illuminance environment and may operate in the GS mode in the low-illuminance environment. In addition, in the RS mode, the image sensor 100 according to the present disclosure may store overflow charges of a photodiode in a capacitor used in the GS mode. As such, an image signal may be obtained even in the high-illuminance environment, and thus, an image of a high dynamic range may be generated.

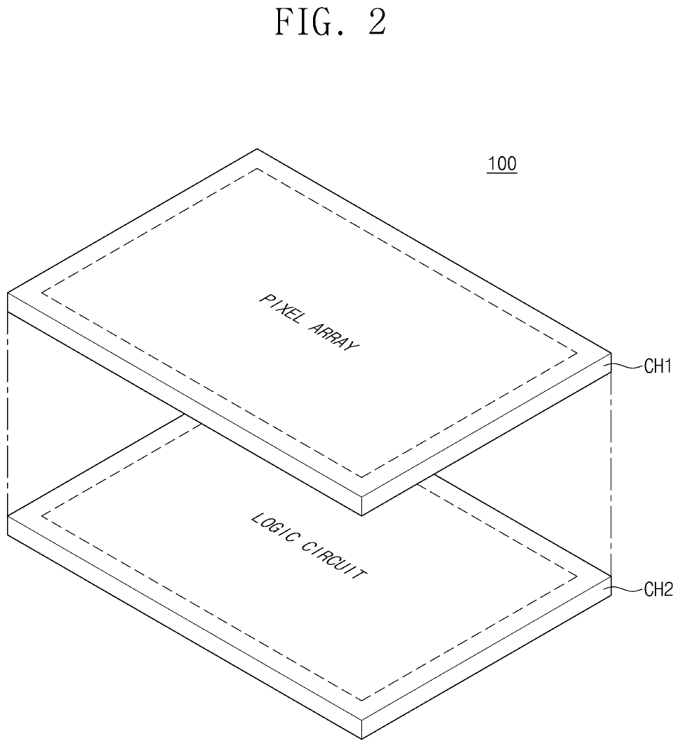

FIG. 2 is a schematic diagram of an image sensor of a stacked structure, according to an embodiment of the present disclosure.

Referring to FIGS. 1 and 2 together, the image sensor 100 may include an upper chip CH1 and a lower chip CH2. The upper chip CH1 may include the pixel array 110 including the plurality of pixels PX of FIG. 1, and the lower chip CH2 may include the mode setting register 120, the timing controller 130, the row driver 140, the ramp signal generator 150, the ADC Circuit 160, the data buffer 170, and the signal processor 190 of FIG. 1. The upper chip CH1 and the lower chip CH2 may be stacked and may exchange signals through TSVs (Through Silicon Vias) or any other connecting means.

As an embodiment of the present disclosure, the image sensor 100 may be implemented with three chips, for example, upper, middle, and lower chips, that are vertically stacked. In this case, the pixel array 110 may be formed to be distributed and disposed in a first chip being the upper chip and a second chip being the middle chip. That is, the first chip being the upper chip may include photodiodes constituting the pixel PX, and the second chip being the middle chip may include transistors that are aligned with and connected to the photodiodes of the first chip. The remaining blocks 120 to 190 other than the pixel array 110 may be formed in a third chip being the lower chip.

FIG. 3 is a block diagram of an image pixel according to an embodiment of the present disclosure. The image pixel PX of FIG. 3 may correspond to one of the image pixels PX of FIG. 1.

Referring to FIG. 3, the image pixel PX may include a photoelectric conversion element 11, a common circuit 12, and a sampling circuit 13.

The photoelectric conversion element 11 may generate and accumulate charges, the amount of which corresponds to the intensity of incident light. For example, the photoelectric conversion element 11 may be a photodiode. However, the present disclosure is not limited thereto. For example, the photoelectric conversion element 11 may include a photo transistor, a photo gate, a pinned photodiode, or a combination thereof.

In an embodiment, the photoelectric conversion element 11 may be implemented with one photodiode. In this case, charges generated by the photoelectric conversion element 11 may be used to generate an image signal.

In an embodiment, the photoelectric conversion element 11 may be implemented with a plurality of photodiodes. In this case, charges generated by the photoelectric conversion element 11 may be used to generate an image signal, AF information, or both the image signal and the AF information.

The common circuit 12 may be electrically connected to the photoelectric conversion element 11. The common circuit 12 may include circuits, which operate in common in the RS mode and the GS mode, such as transistors.

In an embodiment, the common circuit 12 may include a floating diffusion node. In the RS mode or the GS mode, a voltage formed at the floating diffusion node may be output to the column line CL (refer to FIG. 1).

In an embodiment, the common circuit 12 may further include a conversion gain transistor. The conversion gain transistor may be used to provide different conversion gains.

For example, the common circuit 12 may include a first floating diffusion node and a second floating diffusion node, and the conversion gain transistor may be located in an electrical path between the first floating diffusion node and the second floating diffusion node.

In this case, in the RS mode, when the conversion gain transistor is turned off, a first conversion gain corresponding to the capacitance of the first floating diffusion node may be provided. The charges accumulated by the photoelectric conversion element 11 may be converted to a first image signal corresponding to the first conversion gain. Also, in the RS mode, when the conversion gain transistor is turned on, a second conversion gain corresponding to a sum of the capacitance of the first floating diffusion node and the capacitance of the second floating diffusion node may be provided. The charges accumulated by the photoelectric conversion element 11 may be converted to a second image signal corresponding to the second conversion gain. Accordingly, an image signal of a high dynamic range may be generated.

In addition, in the GS mode, one of different conversion gains may be selected by controlling the conversion gain transistor, and an image signal may be generated by using the selected conversion gain.

The sampling circuit 13 may be electrically connected to the common circuit 12. The sampling circuit 13 may include a plurality of capacitors 13_1, and at least one of the plurality of capacitors 13_1 may be used to sample and store a voltage of the floating diffusion node in the GS mode and to store charges that overflow from the photoelectric conversion element 11 in the RS mode.

In an embodiment, the sampling circuit 13 may include a first capacitor C1 and a second capacitor C2.

In the GS mode, a first voltage may be stored in the first capacitor C1 of the sampling circuit 13, and a second voltage may be stored in the second capacitor C2 of the sampling circuit 13. The first voltage stored in the first capacitor C1 may correspond to a voltage of the floating diffusion node that is in a reset state. Accordingly, the first voltage may be called a reset voltage. The second voltage stored in the second capacitor C2 may correspond to a voltage of the floating diffusion node in a state where charges are transferred to the floating diffusion node. Accordingly, the second voltage may be called an image voltage.

In the RS mode, charges that overflow from the photoelectric conversion element 11 may be stored in one of the first and second capacitors C1 and C2 of the sampling circuit 13. For example, charges that overflow from the photoelectric conversion element 11 may be stored in the first capacitor C1. That is, the first capacitor C1 may store the reset voltage in the GS mode and may store charges that overflow from the photoelectric conversion element 11 in the RS mode.

In an embodiment, the sampling circuit 13 may further include a third capacitor C3. The third capacitor C3 may be used to store information about autofocus (AF).

In an embodiment, the sampling circuit 13 may further include a fourth capacitor C4 and a fifth capacitor C5. The fourth and fifth capacitors C4 and C5 may be used to additionally store the reset voltage and the image voltage.

In the GS mode, a fourth voltage being the reset voltage may be stored in the fourth capacitor C4, and a fifth voltage being the image voltage may be stored in the fifth capacitor C5. In this case, a conversion gain corresponding to the fourth voltage may be different from a conversion gain corresponding to the first voltage, and a conversion gain corresponding to the fifth voltage may be different from a conversion gain of the second voltage. Accordingly, an image signal of a high dynamic range may be generated.

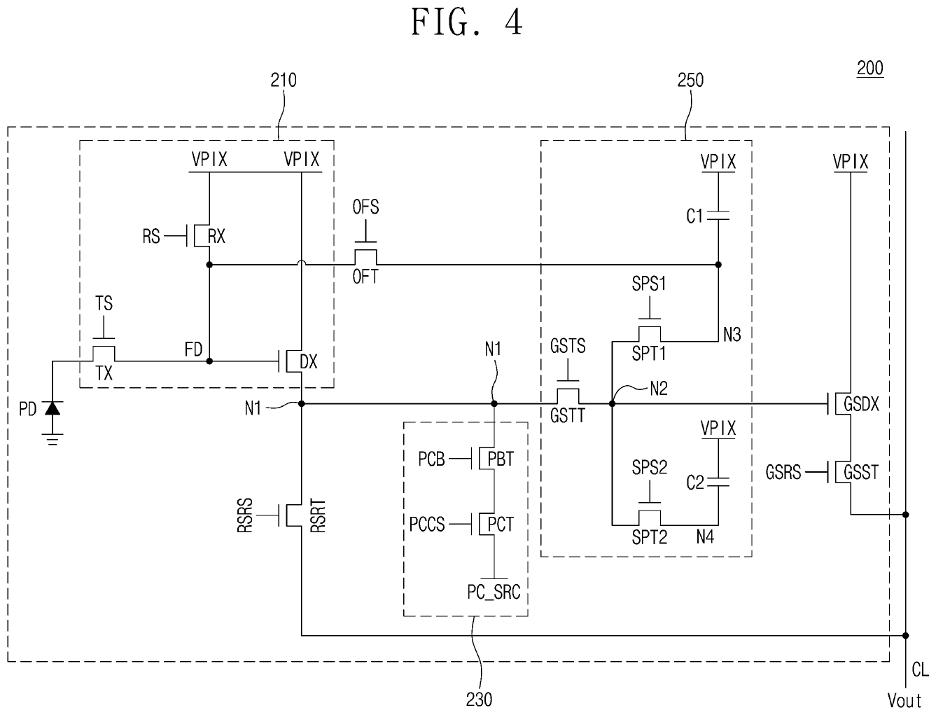

An overflow transistor OFT (refer to FIG. 4) may be located in an electrical path between the plurality of capacitors 13_1 and the common circuit 12. The overflow transistor OFT may be used to store charges that overflow from the photoelectric conversion element 11 in at least one of the plurality of capacitors 13_1.

In an embodiment, a first terminal of the overflow transistor OFT may be electrically connected to the floating diffusion node of the common circuit 12, and a second terminal thereof may be electrically connected to the first capacitor C1. In this case, in the RS mode, the overflow transistor OFT may be turned on in response to an overflow signal OFS (refer to FIG. 4), and thus, charges that overflow from the photoelectric conversion element 11 may be stored in the first capacitor C1.

In an embodiment, the first terminal of the overflow transistor OFT may be electrically connected to the floating diffusion node of the common circuit 12, and the second terminal thereof may be electrically connected in common to the first capacitor C1 and the second capacitor C2 through a sampling transistor. In this case, in the RS mode, the overflow transistor OFT may be turned on in response to the overflow signal OFS, and thus, charges that overflow from the photoelectric conversion element 11 may be stored in the first capacitor C1, the second capacitor C2, or the first and second capacitors C1 and C2 depending on whether the sampling transistor is turned on or turned off.

As described above, the image pixel PX according to the present disclosure may selectively operate in the GS mode or the RS mode. In addition, in the RS mode, the image pixel PX according to the present disclosure may store charges that overflow from the photoelectric conversion element 11 in a capacitor used in the GS mode. As such, an image signal may be obtained even in the high-illuminance environment. Accordingly, an image of a high dynamic range may be generated. Below, configurations and operations of various embodiments of the present disclosure will be described in detail.

FIG. 4 is a circuit diagram of an image pixel according to an embodiment of the present disclosure.

Referring to FIGS. 1 to 4, an image pixel 200 may include a photodiode PD, a common circuit 210, a precharge circuit 230, a sampling circuit 250, and a plurality of transistors OFT, RSRT, GSDX, and GSST. The sampling circuit 250 may include the first and second capacitors C1 and C2.

As a photoelectric conversion element, the photodiode PD may generate and accumulate charges, the amount of which corresponds to the intensity of incident light. For example, the photodiode PD may generate electrons and holes depending on the amount of incident light, the generated electrons may be accumulated in the photodiode PD, and the generated holes move to a reference voltage electrically connected to an anode of the photodiode PD, that is, the generated holes disappear. The amount of charges capable of being maximally accumulated in a photodiode (PD) region may be referred to as a “full well capacity FWC”.

The common circuit 210 may include a transfer transistor TX, a reset transistor RX, a drive transistor DX, and a floating diffusion node FD. When the image pixel 200 operates in the RS mode or the GS mode, the common circuit 210 may output the reset voltage of the floating diffusion node FD and the image voltage corresponding to the amount of charges transferred to the floating diffusion node FD to a first node N1. That is, the common circuit 210 may include circuits that operate in common in the RS mode and the GS mode.

The transfer transistor TX may be located in an electrical path between a cathode of the photodiode PD and the floating diffusion node FD. The transfer transistor TX may be turned on responsive to a transfer control signal TS and may transfer the charges accumulated by the photodiode PD to the floating diffusion node FD. When the photodiode PD is exposed in the high-illuminance environment, the event that the amount of charges generated in an exposure period exceeds the full well capacity FWC may occur. Even though the transfer transistor TX is turned off, the charges, the amount of which exceeds the full well capacity FWC, may overflow and may be transferred to the floating diffusion node FD.

The reset transistor RX may be located in an electrical path between a pixel voltage VPIX and the floating diffusion node FD. The reset transistor RX may reset the floating diffusion node FD by draining charges of the floating diffusion node FD to the pixel voltage VPIX in response to a reset control signal RS.

The drive transistor DX may be located in an electrical path between the pixel voltage VPIX and the first node N1 and may output an output voltage to the first node N1 in response to a voltage of the floating diffusion node FD corresponding to a conversion gain. The conversion gain means a ratio of a capacitance of the floating diffusion node FD and a voltage generated by the transferred charges. That is, the conversion gain may be variable depending on the capacitance of the floating diffusion node FD; in this case, assuming that charges of the same amount are transferred, the conversion gain may decrease when the capacitance of the floating diffusion node FD increases and may increase when the capacitance of the floating diffusion node FD decreases.

The precharge circuit 230 may include a precharge bias transistor PBT and a precharge control transistor PCT connected in series between the first node N1 and a precharge source voltage PC_SRC. The precharge bias transistor PBT may be located in an electrical path between the first node N1 and the precharge control transistor PCT and may be controlled by a precharge bias signal PCB. The precharge control transistor PCT may be located in an electrical path between the precharge bias transistor PBT and the precharge source voltage PC_SRC and may be controlled by a precharge control signal PCCS. For example, the precharge source voltage PC_SRC may be connected to a ground voltage. When the precharge bias signal PCB of the bias voltage is applied to a gate of the precharge bias transistor PBT and the precharge control transistor PCT is turned on in response to the precharge control signal PCCS, the precharge circuit 230 may operate as a current source of the common circuit 210.

A voltage of the first node N1 may be determined by the drive transistor DX, which responds to the floating diffusion node FD, when the precharge circuit 230 operates as a current source. For example, the first node N1 may be precharged or reset by the drive transistor DX connected to the floating diffusion node FD reset during a reset period in the GS mode and the operation of the precharge circuit 230. A voltage may be formed at first node N1 by the drive transistor DX connected to the floating diffusion node FD to which charges are transferred during a sampling period in the GS mode and the operation of the precharge circuit 230.

The sampling circuit 250 may include a GS transfer transistor GSTT, a first sampling transistor SPT1, the first capacitor C1, a second sampling transistor SPT2, and the second capacitor C2.

The GS transfer transistor GSTT may be located in an electrical path between the first node N1 and a second node N2 and may electrically connect the first node N1 and the second node N2 in response to a GS transfer signal GSTS. In the GS mode, during the reset period and the sampling period, the GS transfer transistor GSTT may be turned on and may electrically connect the first node N1 and the second node N2.

When the image pixel 200 operates in the GS mode, the first capacitor C1 may store a first voltage (e.g., a reset voltage) transferred to the second node N2, and the second capacitor C2 may store a second voltage (e.g., an image voltage) transferred to the second node N2.

The first sampling transistor SPT1 may be located in an electrical path between the second node N2 and the first capacitor C1 and may electrically connect the second node N2 to a first terminal of the first capacitor C1 in response to a sampling control signal SPS1. The pixel voltage VPIX may be connected to a second terminal of the first capacitor C1. When the reset voltage that the drive transistor DX drives based on the reset state of the floating diffusion node FD is transferred to the first node N1 and the second node N2, the first sampling transistor SPT1 may be turned on. As such, the reset voltage may be stored in the first capacitor C1.

The second sampling transistor SPT2 may be located between the second node N2 and the second capacitor C2 and may electrically connect the second node N2 to a first terminal of the second capacitor C2 in response to a sampling control signal SPS2. The pixel voltage VPIX may be connected to a second terminal of the second capacitor C2. When the image voltage that the drive transistor DX drives based on the charges transferred from the photodiode PD to the floating diffusion node FD is transferred to the first node N1 and the second node N2, the second sampling transistor SPT2 may be turned on. As such, the image voltage may be stored in the second capacitor C2.

That is, in the GS mode, the reset voltage and the image voltage may be respectively stored in the first capacitor C1 and the second capacitor C2. According to an embodiment, the capacitance of the first capacitor C1 may be implemented to be less than the capacitance of the second capacitor C2.

The overflow transistor OFT may be located in an electrical path between the first terminal of the first capacitor C1 and the floating diffusion node FD and may electrically connect the floating diffusion node FD to the first terminal of the first capacitor C1 in response to the overflow signal OFS.

The first capacitor C1 may store the reset voltage corresponding to the reset state of the floating diffusion node FD when the image pixel 200 operates in the GS mode and may store the overflow charges of the photodiode PD transferred through the overflow transistor OFT when the image pixel 200 operates in the RS mode.

In FIG. 4, the overflow transistor OFT is electrically connected to the first terminal of the first capacitor C1; however, the overflow transistor OFT may be electrically connected to the first terminal of the second capacitor C2, not the first capacitor C1. Only one overflow transistor OFT is illustrated in FIG. 4, but an overflow transistor may be further electrically connected between the floating diffusion node FD and the first terminal of the second capacitor C2. Depending on a dynamic range that the image sensor 100 including the image pixel 200 intends to implement or depending on the amount of charges that overflow from the photodiode PD, the overflow charges may be selectively stored by using a first capacitor, a second capacitor, or both of the first capacitor and the second capacitor.

The pixel control signals may be controlled by the row driver 140, such that the transistors included in the sampling circuit 250 do not operate when the image pixel 200 operates in the RS mode.

The RS row select transistor RSRT may be located in an electrical path between the first node N1 and the column line CL and may electrically connect the first node N1 and the column line CL in response to an RS row selection signal RSRS. In a readout period of the RS mode, the RS row select transistor RSRT transfers a voltage of the first node N1 to the column line CL. The RS row select transistor RSRT may be in a turn-off state when the image pixel 200 operates in the GS mode.

The GS drive transistor GSDX and the GS row select transistor GSST may be located in an electrical path between the second node N2 and the column line CL and may output an output voltage corresponding to a voltage of the second node N2 to the column line CL in response to a GS row selection signal GSRS. The GS drive transistor GSDX and the GS row select transistor GSST may output, to the column line CL, an output signal corresponding to each of the reset voltage stored in the first capacitor C1 and the image voltage stored in the second capacitor C2. The GS drive transistor GSDX and the GS row select transistor GSST is in a turn-off state when the image pixel 200 operates in the RS mode.

In the GS mode, pixels connected to all the rows of the pixel array 110 may be reset at the same point in time and may be exposed during the same time period. After the same exposure period, each of the pixels connected to all the rows of the pixel array 110 may store the reset voltage and the image voltage in the first capacitor C1 and the second capacitor C2, respectively, and may output the output voltages Vout respectively corresponding to the reset voltage and the image voltage stored in the first and second capacitors C1 and C2 in units of a row.

The image sensor 100 including the pixel array 110 composed of the image pixels 200 may include a first semiconductor substrate CH1 in which the photodiode PD, the common circuit 210, and the RS row select transistor RSRT are formed and a second semiconductor substrate CH2 in which the overflow transistor OFT, the precharge circuit 230, the sampling circuit 250, the GS drive transistor GSDX, and the GS row select transistor GSST are formed.

According to another embodiment of the image sensor 100 including the pixel array 110 composed of the image pixels 200, the photodiode PD, the common circuit 210, the RS row select transistor RSRT, and the overflow transistor OFT may be formed in the first semiconductor substrate CH1, and the precharge circuit 230, the sampling circuit 250, the GS drive transistor GSDX, and the GS row select transistor GSST may be formed in the second semiconductor substrate CH2.

The image pixel 200 according to an embodiment of the present disclosure may operate in one of the RS mode or the GS mode in response to the pixel control signals from the row driver 140. In the GS mode, the image pixel 200 may store the reset voltage and the image voltage in two capacitors, that is, the first capacitor C1 and the second capacitor C2, respectively. In the RS mode, the image pixel 200 may store charges that overflow from the photodiode PD in at least one of the two capacitors, that is, the first and second capacitors C1 and C2. That is, charges that overflow from the photodiode PD may be stored by using a capacitor for GS mode, without including a separate capacitor for RS mode. Accordingly, a high dynamic range may be implemented in the RS mode without the increase in the pixel size.

Meanwhile, the description is given with reference to FIG. 4 as the precharge circuit 230 is separately provided. However, this is provided as an example, and embodiments of the present disclosure are not limited thereto. According to an embodiment, the precharge circuit 230 may be replaced with an external current source or may be omitted.

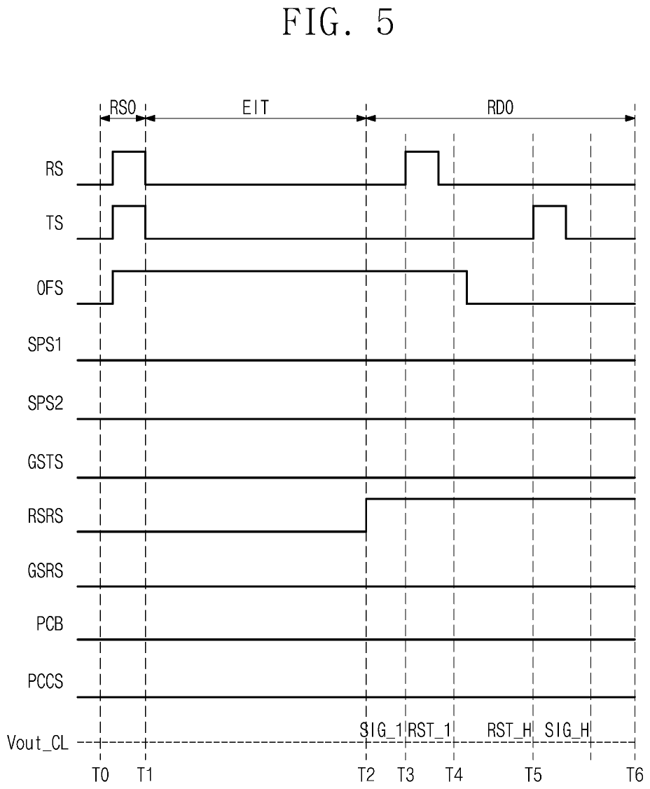

FIG. 5 is a timing diagram that illustrates an operation of an image pixel of FIG. 4 in an RS mode.

Referring to FIGS. 4 and 5, an RS mode operating period may include a reset period RS0, an exposure period EIT, and a readout period RD0.

All electrons present in the floating diffusion node FD, the photodiode PD, and the first capacitor C1 may be removed in the reset period RS0.

The exposure period EIT may refer to a period where the photodiode PD generates electrons based on light received after the reset operation. During the exposure period EIT, when the photodiode PD is exposed to a strong light, charges, the amount of which exceeds the full well capacity FWC, may overflow and may be transferred to the first capacitor C1 through the overflow transistor OFT.

In the readout period RD0, a first image signal SIG_1 corresponding to the amount of overflow charges stored in the first capacitor C1, a first reset signal RST_1 corresponding to a simultaneous reset state of the first capacitor C1 and the floating diffusion node FD, a second reset signal RST_H corresponding to a reset state of the floating diffusion node FD, and a second image signal SIG_H corresponding to the amount of charges accumulated by the photodiode PD may be sequentially output to the column line CL.

In detail, referring to FIG. 5, when the image pixel 200 operates in the RS mode, the row driver 140 maintain the first and second sampling control signals SPS1 and SPS2, the GS transfer signal GSTS, the precharge bias signal PCB, the precharge control signal PCCS, and the GS row selection signal GSRS at the low level, such that the precharge circuit 230, the sampling circuit 250, and the GS row select transistor GSST do not operate.

The reset period RS0 may include a time period from T0 to T1. In the reset period RS0, the reset transistor RX, the transfer transistor TX, and the overflow transistor OFT may be turned on in response to the high levels of the reset control signal RS, the transfer control signal TS, and the overflow signal OFS, and thus, the floating diffusion node FD, the photodiode PD, and the first capacitor C1 may be reset.

The exposure period EIT may include a time period from T1 to T2. In the exposure period EIT, the overflow transistor OFT may be turned on in response to the overflow signal OFS of the high level, and overflow charges, the amount of which exceeds the full well capacity FWC, may be stored in the first capacitor C1 and the floating diffusion node FD.

The readout period RD0 may include a time period from T2 to T6.

At T2, the RS row select transistor RSRT may be turned on in response to the RS row selection signal RSRS of the high level, and the drive transistor DX may output the first image signal SIG_1 to the column line CL.

At T3, as the reset control signal RS transitions to the high level, the reset transistor RX may be turned on, and thus, the floating diffusion node FD and the first capacitor C1 may be reset. Afterwards, the drive transistor DX may output the first reset signal RST_1, which corresponds to the reset state of the first capacitor C1 and the floating diffusion node FD, to the column line CL.

After T4, the overflow transistor OFT may be turned off in response to the overflow signal OFS of the low level, and the drive transistor DX may output the second reset signal RST_H, which corresponds to the reset state of the floating diffusion node FD, to the column line CL.

At T5, as the transfer control signal TS transitions to the high level, the transfer transistor TX may be turned on, and thus, the charges accumulated by the photodiode PD may be transferred to the floating diffusion node FD. Afterwards, the drive transistor DX may output the second image signal SIG_H to the column line CL in response to a voltage of the floating diffusion node FD.

The signals SIG_1, RST_1, RST_H, and SIG_H sequentially output to the column line CL in the readout period RD0 may be input to the ADC Circuit 160 of FIG. 1. The ADC Circuit 160 may generate a first digital image signal by using the ramp signal RAMP, the first image signal SIG_1, and the first reset signal RST_1 and may generate a second digital image signal by using the ramp signal RAMP, the second image signal SIG_H, and the second reset signal RST_H. Afterwards, the data buffer 170 and the signal processor 190 may generate a final image signal by using the first and second digital image signals.

A digital image signal generated by an image pixel exposed to the strong light of the high-illuminance environment may be of a saturated value; however, according to an embodiment of the present disclosure, the first digital image signal generated by using the first capacitor C1 may express a valid image value. That is, in the RS mode, a valid image signal may be generated even in the high-illuminance environment by using a capacitor used in the GS mode, and thus, a dynamic range may be improved.

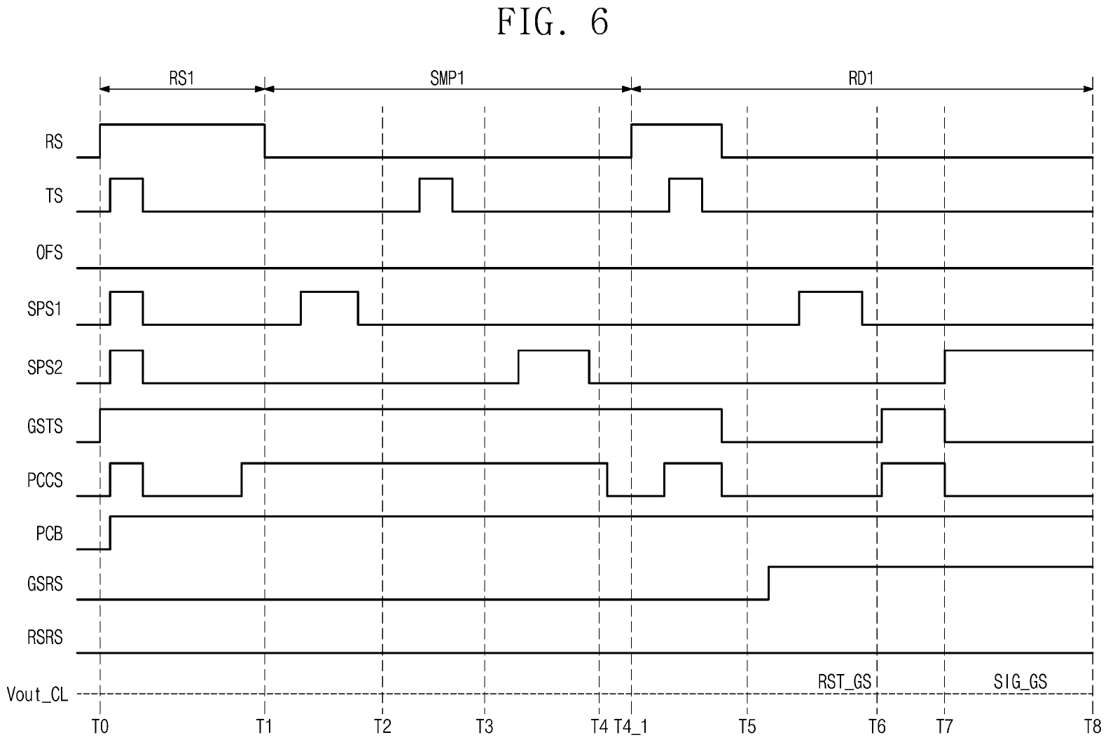

FIG. 6 is a timing diagram that illustrates an operation of an image pixel of FIG. 4 in a GS mode.

Referring to FIGS. 4 and 6, a GS mode operating period may include a reset period RS1, a sampling period SMP1, and a readout period RD1.

The reset period RS1 refers to a period in which the floating diffusion node FD, the photodiode PD, the first node N1, the second node N2, and the first and second capacitors C1 and C2 are reset. The reset period RS1 may include a time period from T0 to T1.

In a time period from T0 to T1, the reset transistor RX may be turned on responsive to the reset control signal RS of the high level, and thus, the floating diffusion node FD may be reset. Also, the GS transfer transistor GSTT may be turned on in response to the GS transfer signal GSTS of the high level, and thus, the first node N1 and the second node N2 may be electrically connected. Also, as the first sampling transistor SPT1 and the second sampling transistor SPT2 are turned on in response to the sampling control signal SPS1 of the high level and the sampling control signal SPS2 of the high level, the first and second capacitors C1 and C2 may be electrically connected to the second node N2. In addition, the precharge bias transistor PBT and the precharge control transistor PCT of the precharge circuit 230 may be turned on in response to the precharge bias signal PCB of the high level and the precharge control signal PCCS of the high level, and thus, the precharge circuit 230 may operate as a current source. According to the above bias condition, the drive transistor DX may reset the first and second capacitors C1 and C2 by using a voltage corresponding to the floating diffusion node FD.

The sampling period SMP1 refers to a period in which the reset voltage and the image voltage are respectively stored in the first capacitor C1 and the second capacitor C2. The sampling period SMP1 may include a time period from T1 to T4_1.

In a time period from T1 to T2, as the sampling control signal SPS1 transitions to the high level, the first sampling transistor SPT1 may be turned on, and thus, a voltage of the reset floating diffusion node FD may be stored in the first capacitor C1.

In a time period from T2 to T3, as the transfer control signal TS transitions to the high level, the transfer transistor TX may be turned on, and thus, the charges generated by the photodiode PD may be transferred to the floating diffusion node FD.

In a time period from T3 to T4, as the sampling control signal SPS2 transitions to the high level, the second sampling transistor SPT2 may be turned on, and thus, a voltage corresponding to the amount of charges transferred to the floating diffusion node FD may be stored in the second capacitor C2. According to an embodiment, a time period where the sampling control signals SPS1 and SPS2 maintain the high level may be longer than a time period where the charge sharing is made between the first capacitor C1 and the second capacitor C2.

The readout period RD1 may include a time period in which a reset signal RST_GS corresponding to the reset voltage stored in the first capacitor C1 and an image signal SIG_GS corresponding to the image voltage stored in the second capacitor C2 are transferred to the column line CL. The readout period RD1 may include a time period from T4_1 to T8.

In a time period from T4_1 to T5, the reset transistor RX may be turned on such that the floating diffusion node FD is reset. Also, the first node N1 and the second node N2 may be reset by turning on the GS transfer transistor GSTT and turning on the precharge bias transistor PBT and the precharge control transistor PCT of the precharge circuit 230, such that the precharge circuit 230 operates as a current source.

In a time period from T5 to T6, the precharge control transistor PCT may be turned off by the precharge control signal PCCS of the low level. Afterwards, as the GS row selection signal GSRS transitions to the high level, the GS row select transistor GSST may be turned on. Also, the sampling control signal SPS1 may transition to the high level, and thus, the first sampling transistor SPT1 may be turned on. According to the above bias condition, the reset voltage stored in the first capacitor C1 may be applied to the second node N2, and the GS drive transistor GSDX may output the reset signal RST_GS to the column line CL.

In a time period from T6 to T7, the precharge control transistor PCT and the GS transfer transistor GSTT may be turned on by allowing the precharge control signal PCCS and the GS transfer signal GSTS to transition to the high level. As such, the second node N2 may be again reset.

In a time period from T7 to T8, the second sampling transistor SPT2 may be turned on in response to the sampling control signal SPS2 of the high level. As such, the image voltage stored in the second capacitor C2 may be applied to the second node N2, and the GS drive transistor GSDX may then output the image signal SIG_GS to the column line CL.

The signals RST_GS and SIG_GS sequentially output to the column line CL in the readout period RD1 may be input to the ADC Circuit 160 of FIG. 1, and the ADC Circuit 160 may generate a digital image signal for a global shutter mode by using the ramp signal RAMP, the reset signal RST_GS, and the image signal SIG_GS.

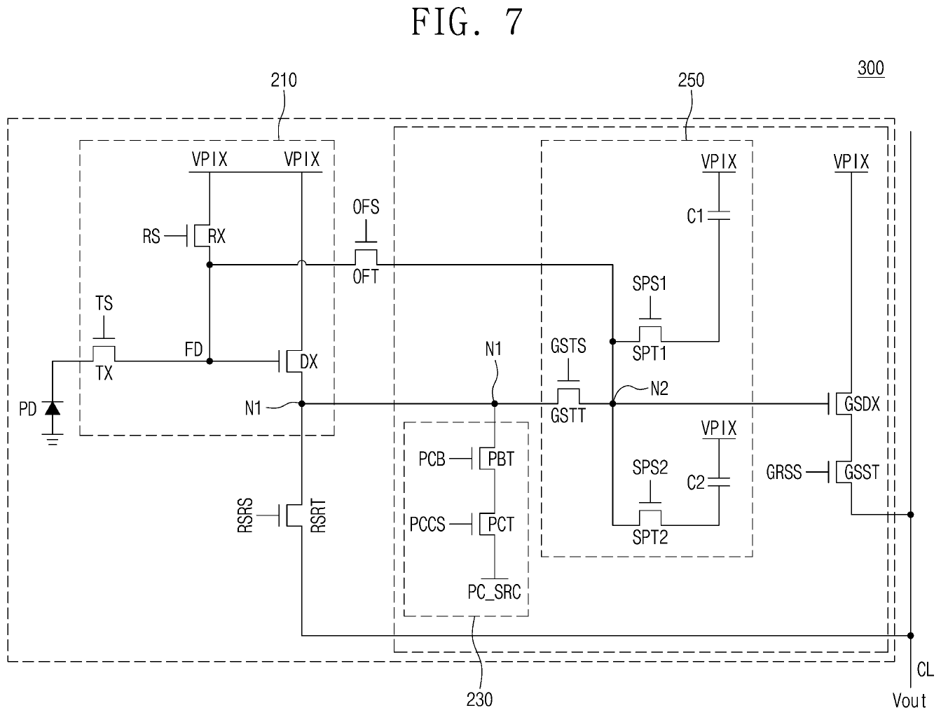

FIG. 7 is a circuit diagram of an image pixel according to an embodiment of the present disclosure.

Referring to FIGS. 4 and 7 together, an image pixel 300 includes the same configuration as the image pixel 200 of FIG. 4 except that the overflow transistor OFT is electrically connected to the second node N2, not directly connected to the first terminal of the first capacitor C1. Thus, additional description associated with the same components will be omitted to avoid redundancy.

A first terminal of the overflow transistor OFT of the image pixel 300 is connected to the floating diffusion node FD, and a second terminal of the overflow transistor OFT is electrically connected in common to the first sampling transistor SPT1 and the second sampling transistor SPT2.

When the image pixel 300 operates in the RS mode, in the exposure period EIT, the overflow transistor OFT may be turned on in response to the overflow signal OFS. In this case, one of the first and second sampling transistors SPT1 and SPT2 may be turned on in response to the sampling control signals SPS1 and SPS2, or the first and second sampling transistors SPT1 and SPT2 may be turned on together in response to the sampling control signals SPS1 and SPS2. As such, the charges that overflow from the photodiode PD to the floating diffusion node FD may be stored in the first capacitor C1, the second capacitor C2, or the first and second capacitors C1 and C2.

When the image pixel 300 operates in the GS mode, the reset voltage may be stored in the first capacitor C1, and the image voltage may be stored in the second capacitor C2. In this case, the capacitance of the first capacitor C1 may be implemented to be less than the capacitance of the second capacitor C2. Depending on a dynamic range to be implemented, one of the first capacitor C1 and the second capacitor C2 may be selected as a capacitor storing the overflow charges, or the first capacitor C1 and the second capacitor C2 may be selected together as a capacitor storing the overflow charges. The sampling control signals SPS1 and SPS2 may be controlled to selectively utilize the first capacitor C1 and/or the second capacitor C2.

An operating timing for the RS mode or the GS mode of the image pixel 300 is the same as that described above except for the sampling control signals SPS1 and SPS2, and thus, additional description will be omitted to avoid redundancy.

As described above, the image pixel 300 according to the present disclosure may selectively operate in the GS mode or the RS mode. In addition, in the RS mode, the image pixel 300 according to the present disclosure may selectively store the charges that overflow from the photodiode PD in a capacitor (e.g., C1, C2, or C1 and C2) used in the GS mode. Accordingly, an image of a high dynamic range may be generated.

FIG. 8 is a circuit diagram of an image pixel according to an embodiment of the present disclosure.

Referring to FIG. 8, an image pixel 400 includes the same configuration of the image pixel 200 of FIG. 4 except that the conversion gain transistor CGT is further included in an electrical path between the reset transistor RX and the floating diffusion node FD of FIG. 4. Thus, additional description associated with the same components will be omitted to avoid redundancy.

A common circuit 410 of the image pixel 400 includes the reset transistor RX and the conversion gain transistor CGT electrically connected in series between the pixel voltage VPIX and a first floating diffusion node FD1 and includes a second floating diffusion node FD2 electrically connected in common to the reset transistor RX and the conversion gain transistor CGT.

When the image pixel 400 operates in the RS mode, the conversion gain transistor CGT may be turned off. In this case, the charges accumulated by the photodiode PD may be converted to a first image signal by using only the capacitance of the first floating diffusion node FD1. That is, the first image signal corresponding to a first conversion gain CG1 may be generated by using only the capacitance of the first floating diffusion node FD1.

Also, when the image pixel 400 operates in the RS mode, the conversion gain transistor CGT may be turned on. In this case, the charges accumulated by the photodiode PD may be converted to a second image signal by using a sum of the capacitance of the first floating diffusion node FD1 and the capacitance of the second floating diffusion node FD2. That is, the second image signal corresponding to a second conversion gain CG2 may be generated by using a sum of the capacitance of the first floating diffusion node FD1 and the capacitance of the second floating diffusion node FD2.

Also, in the RS mode, the image pixel 400 may store the charges that overflow from the photodiode PD in the first capacitor C1. That is, a third image signal corresponding to a third conversion gain CG3 may be generated by using the capacitance of the first capacitor C1.

According to the above description, image signals may be generated by using at least three conversion gains CG through one exposure operation, and an image of a high dynamic range (HDR) may be generated by using the corresponding image signals.

Meanwhile, in the GS mode, the image pixel 400 may use one conversion gain by turning off the conversion gain transistor CGT or turning on the conversion gain transistor CGT.

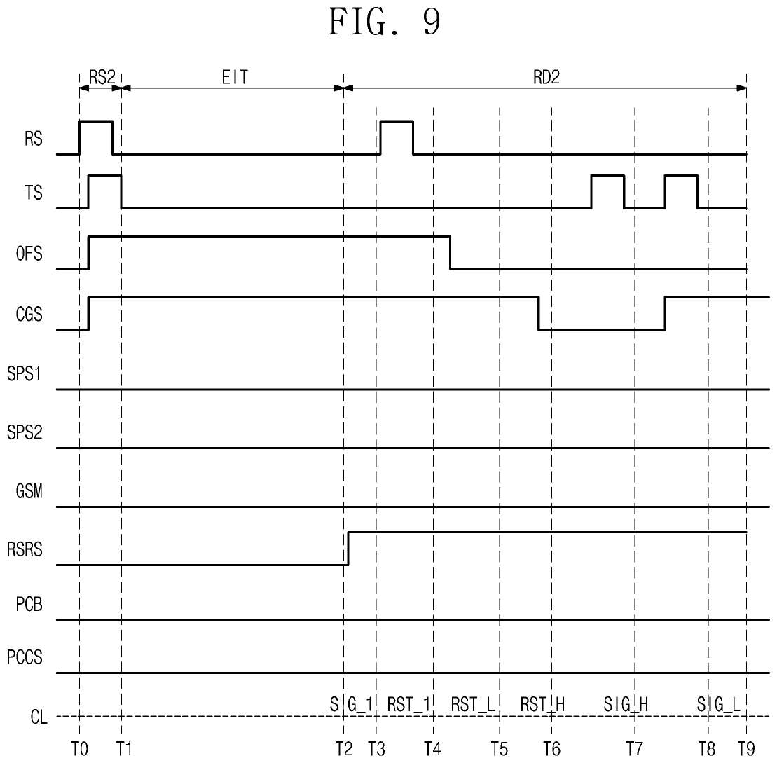

FIG. 9 is a timing diagram that illustrates an operation of an image pixel of FIG. 8 in an RS mode.

Referring to FIGS. 5 and 9 together, the timing diagram of FIG. 9 further includes a conversion gain signal CGS being a control signal of the conversion gain transistor CGT, compared to FIG. 5. Thus, additional description associated with the same operations will be omitted to avoid redundancy.

In a reset period RS2, the conversion gain transistor CGT may be turned on in response to the conversion gain signal CGS of the high level, and the reset transistor RX may also be turned on in response to the reset control signal RS of the high level. As such, the first floating diffusion node FD1 and the second floating diffusion node FD2 may be reset.

In the exposure period EIT, the conversion gain transistor CGT may be turned on in response to the conversion gain signal CGS of the high level. In this case, the charges that overflow from the photodiode PD may be transferred to the first capacitor C1 through the overflow transistor OFT turned on by the overflow signal OFS of the high level.

A readout period RD2 may include a time period from T2 to T9.

In a time period from T2 to T3, the RS row select transistor RSRT may be turned on in response to the RS row selection signal RSRS of the high level. As such, the first image signal SIG_1 corresponding to the amount of charges stored in the first capacitor C1 may be output to the column line CL.

In a time period from T3 to T4, as the reset control signal RS transitions to the high level, the reset transistor RX may be turned on. Also, charges present in the first floating diffusion node FD1, the second floating diffusion node FD2, and the first capacitor C1 may be removed through the turned-on overflow transistor OFT and the turned-on conversion gain transistor CGT, and the first reset signal RST_1 corresponding to the reset state of the first floating diffusion node FD1, the second floating diffusion node FD2, and the first capacitor C1 may be output to the column line CL.

In a time period from T4 to T5, the overflow transistor OFT may be turned off in response to the overflow signal OFS of the low level, and thus, a third reset signal RST_L corresponding to the reset state of the first floating diffusion node FD1 and the second floating diffusion node FD2 may be output to the column line CL.

In a time period from T5 to T6, as the conversion gain transistor CGT is turned off in response to the conversion gain signal CGS of the low level, the second reset signal RST_H corresponding to the reset state of the first floating diffusion node FD1 may be output to the column line CL.

In a time period from T6 to T7, the transfer transistor TX may be turned on in response to the transfer control signal TS of the high level. In this case, the charges accumulated by the photodiode PD may be transferred to the first floating diffusion node FD1, and the second image signal SIG_H corresponding to the amount of charges transferred to the first floating diffusion node FD1 may be output to the column line CL.

In a time period from T7 to T8, the conversion gain transistor CGT may be turned on in response to the conversion gain signal CGS of the high level. As such, the charges transferred to the first floating diffusion node FD1 may be shared with the second floating diffusion node FD2. Afterwards, a third image signal SIG_L corresponding to a state of the first floating diffusion node FD1 and the second floating diffusion node FD2 between which the charge sharing is made may be output to the column line CL.

That is, in the readout period RD2, the first image signal SIG_1 corresponding to the amount of overflow charges, the second image signal SIG_H obtained by converting the charges generated by the photodiode PD with a high conversion gain using only the capacitance of the first floating diffusion node FD1, the third image signal SIG_L obtained by converting the charges generated by the photodiode PD with a low conversion gain using a sum of the capacitance of the first floating diffusion node FD1 and the capacitance of the second floating diffusion node FD2 may be sequentially output to the column line CL.

The signals SIG_1, RST_1, RST_L, RST_H, SIG_H, and SIG_L sequentially output to the column line CL in the readout period RD2 may be input to the ADC Circuit 160 of FIG. 1. The ADC Circuit 160 may generate a first digital image signal by using the ramp signal RAMP, the first image signal SIG_1, and the first reset signal RST_1, may generate a second digital image signal by using the ramp signal RAMP, the second image signal SIG_H, and the second reset signal RST_H, and may generate a third digital image signal by using the ramp signal RAMP, the third image signal SIG_L, and the third reset signal RST_L. Afterwards, the data buffer 170 and the signal processor 190 may generate a final image signal by using the first to third digital image signals.

When an image sensor including a pixel array implemented with the image pixel 400 operates in the RS mode, the image sensor may generate a valid image signal even in the high-illuminance environment by using a capacitor used in the GS mode and may generate image signals using different conversion gains. Accordingly, a higher dynamic range may be obtained.

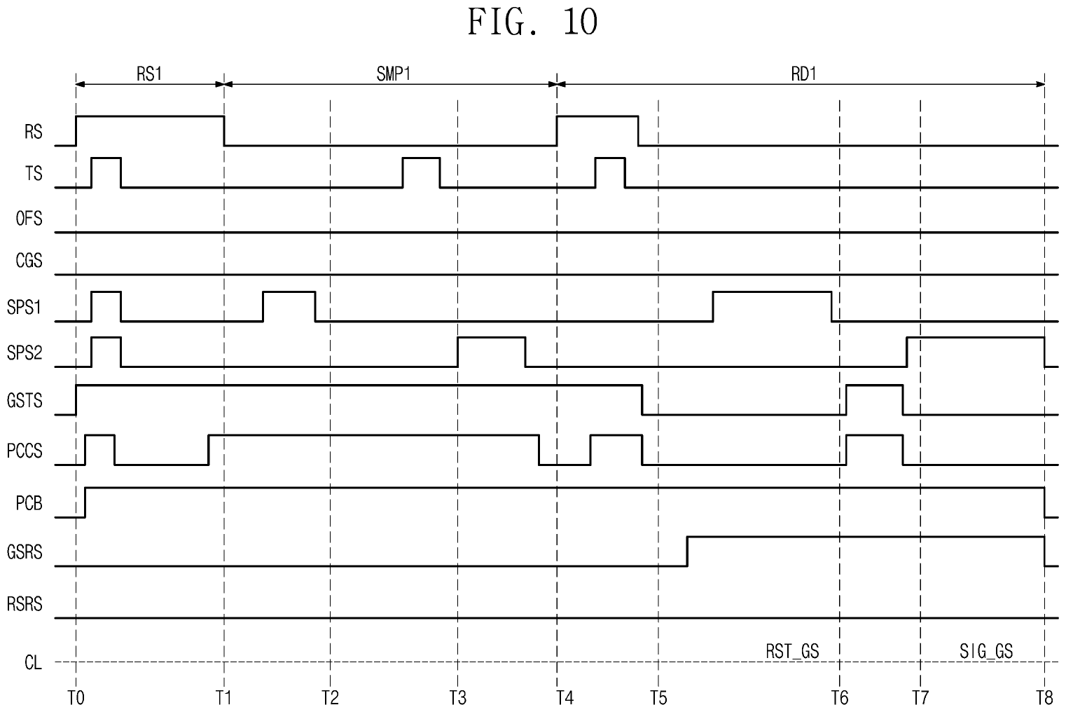

FIG. 10 is a timing diagram that illustrates an operation of an image pixel of FIG. 8 in a GS mode.

Referring to FIGS. 6 and 10 together, control signals may be identically controlled except that the timing diagram of FIG. 10 further includes the conversion gain signal CGS for the conversion gain transistor CGT, compared to the timing diagram of FIG. 6. Thus, additional description associated with the same operation will be omitted to avoid redundancy.

In the GS mode, the conversion gain transistor CGT may be turned on or turned off. That is, in the GS mode, one of a higher conversion gain or a lower conversion gain may be selectively used in units of frame. An example in which the conversion gain transistor CGT is turned on in response to the conversion gain signal CGS of the high level, that is, a lower conversion gain is selected and used is illustrated in FIG. 10.

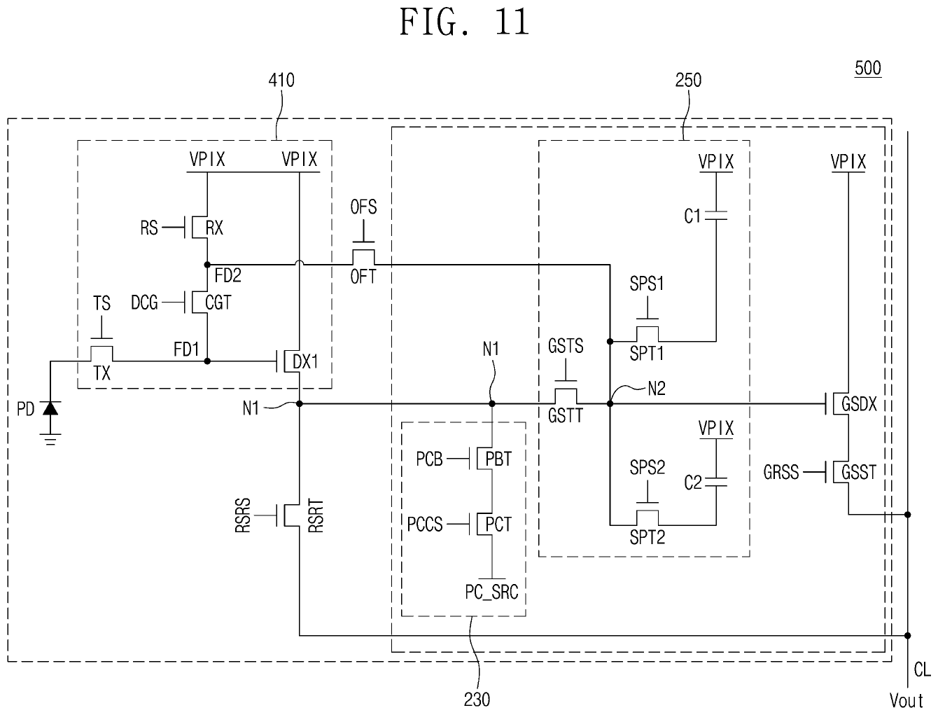

FIG. 11 is a circuit diagram of an image pixel according to an embodiment of the present disclosure.

Referring to FIGS. 8 and 11 together, an image pixel 500 includes the same configuration as the image pixel 400 of FIG. 8 except that the overflow transistor OFT is electrically connected to the second node N2, not directly connected to the first terminal of the first capacitor C1. Thus, additional description associated with the same components will be omitted to avoid redundancy.

A first terminal of the overflow transistor OFT of the image pixel 500 is connected to the second floating diffusion node FD2, and a second terminal of the overflow transistor OFT is connected in common to the first sampling transistor SPT1 and the second sampling transistor SPT2.

When the image pixel 500 operates in the RS mode, in an exposure period, the overflow transistor OFT may be turned on in response to the overflow signal OFS. In this case, one of the first and second sampling transistors SPT1 and SPT2 may be turned on in response to the sampling control signals SPS1 and SPS2, or the first and second sampling transistors SPT1 and SPT2 may be turned on together in response to the sampling control signals SPS1 and SPS2. As such, the charges that overflow from the photodiode PD to the floating diffusion node FD may be stored in the first capacitor C1, the second capacitor C2, or the first and second capacitors C1 and C2. Accordingly, a plurality of conversion gains may be provided through one exposure operation, and an image of a high dynamic range (HDR) may be generated.

Meanwhile, when the image pixel 500 operates in the GS mode, the reset voltage may be stored in the first capacitor C1, and the image voltage may be stored in the second capacitor C2. In this case, the capacitance of the first capacitor C1 may be implemented to be less than the capacitance of the second capacitor C2. Also, depending on a dynamic range to be implemented, one of the first capacitor C1 and the second capacitor C2 may be selected as a capacitor storing the overflowed charges, or the first capacitor C1 and the second capacitor C2 may be selected together as a capacitor storing the overflowed charges. The sampling control signals SPS1 and SPS2 may be controlled to selectively utilize the first capacitor C1 and/or the second capacitor C2.

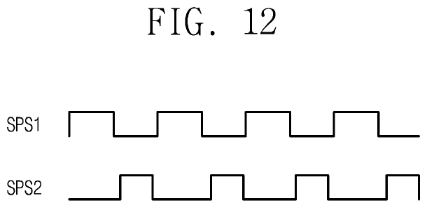

FIG. 12 illustrates the sampling control signals SPS1 and SPS2 in a sampling period when the image pixel 500 of FIG. 11 operates in the GS mode. The charges that overflow from the photodiode PD may be distributed and stored in the first capacitor C1 and the second capacitor C2 by adjusting the sampling control signals SPS1 and SP2 differently, such that high-level durations do not overlap each other. As another example, the sampling control signals SPS1 and SP2 may be differently controlled, such that duty cycles (or ratios) are different from each other.

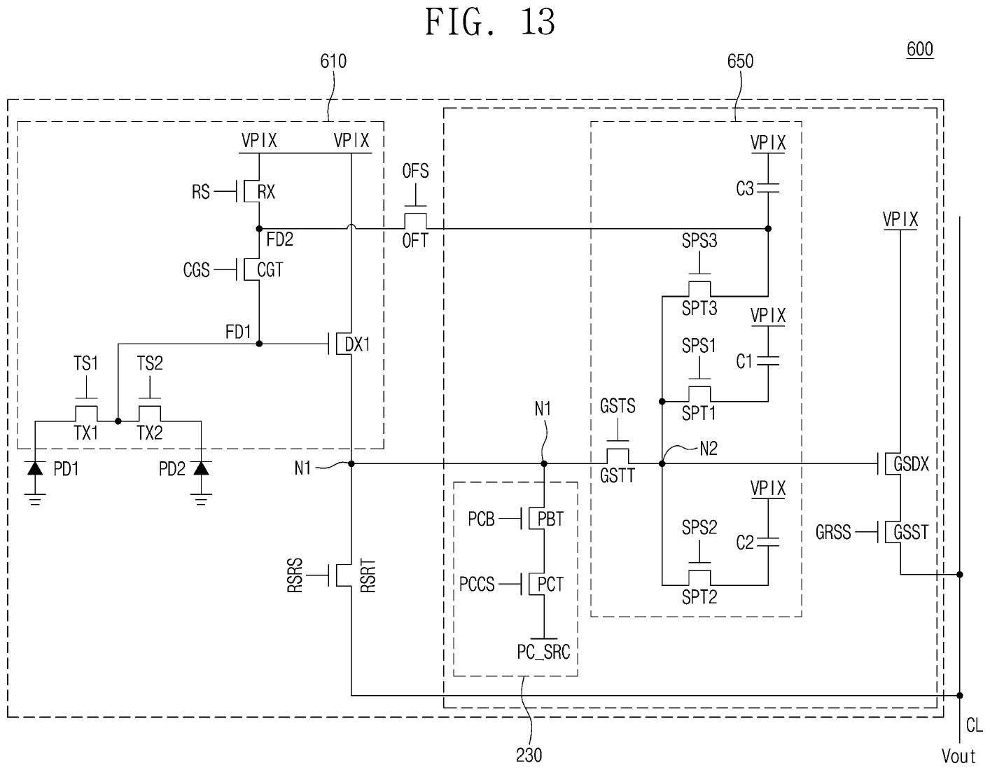

FIG. 13 is a circuit diagram of an image pixel according to an embodiment of the present disclosure.

Referring to FIGS. 8 and 13 together, an image pixel 600 may include the same configuration as the image pixel 400 of FIG. 8 except that the image pixel 600 further includes a second photodiode PD2, a second transfer transistor TX2 of a common circuit 610, and a third capacitor C3 and a third sampling transistor SPT3 of a sampling circuit 650. Thus, additional description associated with the same components will be omitted to avoid redundancy.

The second photodiode PD2 is connected to the first floating diffusion node FD1 through the second transfer transistor TX2. The first and second photodiodes PD1 and PD2 may correspond to one micro lens. An image sensor including the image pixel 600 may generate an autofocus signal, that is, information about a focal length of a subject by using output signals generated by the first photodiode PD1 and the second photodiode PD2.

A first terminal of the third capacitor C3 may be electrically connected to the second floating diffusion node FD2 through the overflow transistor OFT and may be electrically connected to the second node N2 through the third sampling transistor SPT3. A second terminal of the third capacitor C3 may be electrically connected to the pixel voltage VPIX.

In the RS mode, the third capacitor C3 may store charges that overflow from the photodiodes PD1 and PD2. In the GS mode, the third capacitor C3 may store charges corresponding to the charges accumulated by one of the first photodiode PD1 or the second photodiode PD2.

A capacitance of the third capacitor C3 may be implemented to be less than the capacitance of the first capacitor C1 storing the reset voltage and the capacitance of the second capacitor C2 storing the image voltage. The capacitance of the first capacitor C1 may be implemented to be less than the capacitance of the second capacitor C2.

An image pixel including a pixel array composed of the image pixels 600 may generate an autofocus signal together with an image signal of a high dynamic range in the RS mode and may generate an autofocus signal and an image signal together in the GS mode.

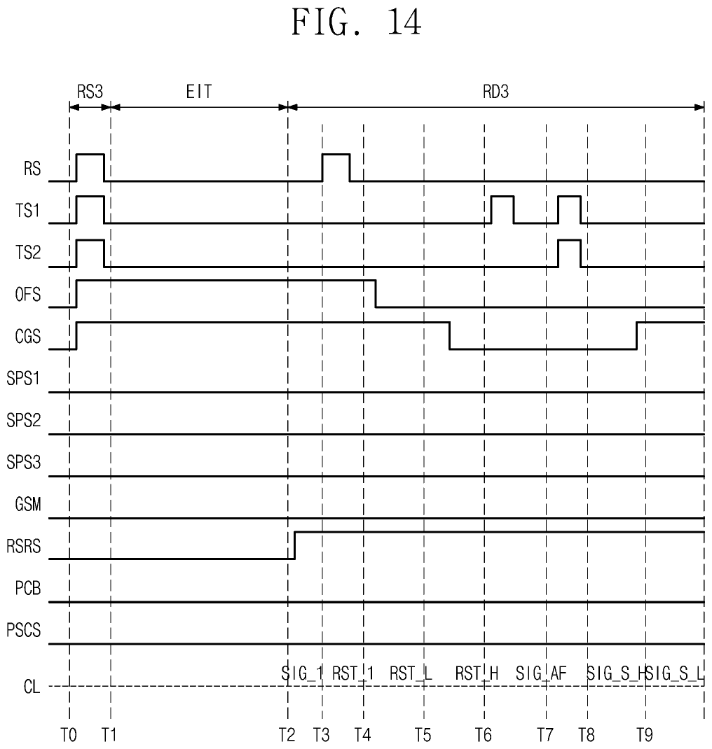

FIG. 14 is a timing diagram that illustrates an operation of an image pixel of FIG. 13 in an RS mode.

Referring to FIGS. 9 and 14 together, the timing diagram of FIG. 14 may further include a second transfer control signal TS2 being a control signal of the second transfer transistor TX2 and a third sampling signal SPS3, compared to the timing diagram of FIG. 9. Thus, additional description associated with the same operations will be omitted to avoid redundancy.

In a reset period RS3, the reset transistor RX, the conversion gain transistor CGT, and the overflow transistor OFT may be turned on. As such, the first floating diffusion node FD1, the second floating diffusion node FD2, and the third capacitor C3 may be reset.

In the exposure period EIT, charges may be generated by the first and second photodiodes PD1 and PD2 depending on an incident light. Charges, the amount of which exceeds the full well capacity FWC, from among the charges generated by the first photodiode PD1 may overflow the turned-off first transfer transistor TX1, and charges, the amount of which exceeds the full well capacity FWC, from among the charges generated by the second photodiode PD2 may overflow the turned-off second transfer transistor TX2. Afterwards, the overflow charges may be transferred to and stored in the third capacitor C3 through the turned-on conversion gain transistor CGT and the turned-on overflow transistor OFT.

A readout period RD3 may include a time period from T2 to T9.

In a time period from T2 to T3, the RS row select transistor RSRT may be turned on in response to the RS row selection signal RSRS of the high level. As such, the first image signal SIG_1 corresponding to the amount of charges stored in the third capacitor C3 may be output to the column line CL.

In a time period from T3 to T4, as the reset control signal RS transitions to the high level, the reset transistor RX may be turned on. In this case, the charges that overflow to the first floating diffusion node FD1, the second floating diffusion node FD2, and the third capacitor C3 may be removed through the turned-on overflow transistor OFT and the turned-on conversion gain transistor CGT. Afterwards, the first reset signal RST_1 corresponding to the reset state of the first floating diffusion node FD1, the second floating diffusion node FD2, and the third capacitor C3 may be output to the column line CL.

In a time period from T4 to T5, the overflow transistor OFT may be turned off in response to the overflow signal OFS of the low level. Afterwards, the third reset signal RST_L corresponding to the reset state of the first floating diffusion node FD1 and the second floating diffusion node FD2 may be output to the column line CL.

In a time period from T5 to T6, the conversion gain transistor CGT may be turned off in response to the conversion gain signal CGS of the low level. Afterwards, the second reset signal RST_H corresponding to the reset state of the first floating diffusion node FD1 may be output to the column line CL.

In a time period from T6 to T7, the first transfer transistor TX1 may be turned on in response to the first transfer control signal TS1 of the high level. Afterwards, the charges accumulated by the first photodiode PD1 may be transferred to the first floating diffusion node FD1, and an output signal SIG_AF corresponding to a voltage of the first floating diffusion node FD1 may be output to the column line CL.

In a time period from T7 to T8, the second transfer transistor TX2 may be turned on in response to the second transfer control signal TS2 of the high level. As such, the charges accumulated by the second photodiode PD2 may be transferred to the first floating diffusion node FD1. Accordingly, a sum of the charges transferred from the first floating diffusion node FD1 and the second photodiode PD2 may be stored at the first floating diffusion node FD1, and a second image signal SIG_S_H corresponding to a voltage of the first floating diffusion node FD1 may be output to the column line CL. In this case, according to an embodiment, the first transfer transistor TX1 may be turned on together by allowing the first transfer control signal TS1 to transition to the high level.

In a time period from T8 to T9, the conversion gain transistor CGT may be turned on in response to the conversion gain signal CGS of the high level. In this case, the charges transferred to the first floating diffusion node FD1 may be shared with the second floating diffusion node FD2. Afterwards, a third image signal SIG_S_L corresponding to a voltage of the first floating diffusion node FD1 and the second floating diffusion node FD2 between which the charge sharing is made may be output to the column line CL.

That is, in the readout period RD3, the first image signal SIG_1, the output signal SIG_AF, the second image signal SIG_H, and the third image signal SIG_L may be sequentially output. In an embodiment, the first image signal SIG_1 may correspond to the overflow charges. The output signal SIG_AF may correspond to the amount of charges generated by one photodiode PD. The second image signal SIG_S_H may be a signal obtained by converting the charges generated by two photodiodes PD with the high conversion gain. The third image signal SIG_S_L may be a signal obtained by converting the charges generated by two photodiodes PD with the low conversion gain.

The signals SIG_1, RST_1, RST_L, RST_H, SIG_AF, SIG_S_H, and SIG_S_L sequentially output to the column line CL in the readout period RD3 may be input to the ADC Circuit 160 of FIG. 1. The ADC Circuit 160 may generate a first digital image signal by using the ramp signal RAMP, the first image signal SIG_1, and the first reset signal RST_1, may generate a second digital image signal by using the ramp signal RAMP, the second image signal SIG_S_H, and the second reset signal RST_H, may generate a third digital image signal by using the ramp signal RAMP, the third image signal SIG_S_L, and the third reset signal RST_L. Also, the ADC Circuit 160 may further generate an autofocus signal by using the output signal SIG_AF and the second image signal SIG_S_H. Afterwards, the data buffer 170 and the signal processor 190 may generate a final image signal by using the first to third digital image signals. An image sensor may transfer the autofocus signal to an application processor together with the final image signal.

As described above, when an image sensor including a pixel array composed of the image pixels 600 operates in the RS mode, after one exposure operation, the image sensor may secure a high dynamic range (HDR) through image signals using different conversion gains and an image signal and using a capacitor used in the GS mode. Also, the image sensor including the pixel array composed of the image pixels 600 may generate autofocus information together with the image signals.

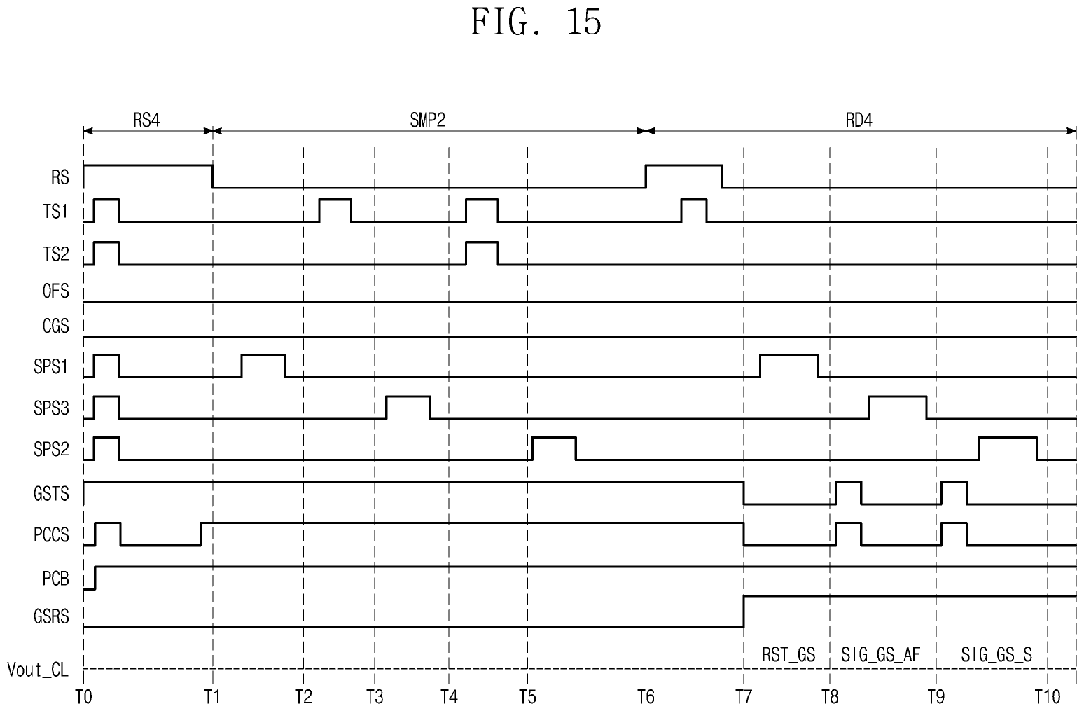

FIG. 15 is a timing diagram for describing an operation of an image pixel of FIG. 12 in a GS mode.

Referring to FIGS. 10 and 15 together, the timing diagram of FIG. 15 further includes the second transfer control signal TS2 and the third sampling signal SPS3, compared to the timing diagram of FIG. 10. Thus, additional description associated with the same operations will be omitted to avoid redundancy.

Compared to the reset period RS1 of FIG. 10, an operation in which the second photodiode PD2 is reset through the second transfer transistor TX2 turned on by the second transfer control signal TS2 of the high level may be further performed in a reset period RS4. That is, in the reset period RS4, the first floating diffusion node FD1, the second floating diffusion node FD2, the first capacitor C1, the second capacitor C2, and the third capacitor C3 may be reset together.

The sampling period SMP2 may include a time period from T1 to T6.

In a time period from T1 to T2, as the sampling control signal SPS1 transitions to the high level, the first sampling transistor SPT1 may be turned on. As such, a voltage of the reset floating diffusion nodes FD1 and FD2 may be stored in the first capacitor C1.

In a time period from T2 to T3, the first transfer control signal TS1 may transition to the high level, and thus, the charges generated by the first photodiode PD1 may be transferred to the first floating diffusion node FD1 and the second floating diffusion node FD2.

In a time period from T3 to T4, the third sampling signal SPS3 may transition to the high level such that the third sampling transistor SPT3 is turned on. In this case, a voltage corresponding to the amount of the charges transferred from the first photodiode PD1 to the floating diffusion nodes FD1 and FD2 may be stored in the third capacitor C3.

In a time period from T4 to T5, as the second transfer control signal TS2 and the first transfer control signal TS1 transition to the high level, the charges generated by the second photodiode PD2 and the charges generated by the first photodiode PD1 may be stored at the first floating diffusion node FD1 and the second floating diffusion node FD2.

In a time period from T5 to T6, the sampling control signal SPS2 may transition to the high level such that the second sampling transistor SPT2 is turned on. In this case, a voltage corresponding to a sum of the charges transferred from the first and second photodiodes PD1 and PD2 to the first and second floating diffusion nodes FD1 and FD2 may be stored in the second capacitor C2.

A readout period RD4 may include a time period from T6 to T10.

In a time period from T6 to T7, the first node N1 and the second node N2 may be reset.

In a time period from T7 to T8, as the sampling control signal SPS1 transitions to the high level, the first sampling transistor SPT1 may be turned on. Accordingly, the first reset signal RST_GS corresponding to the reset voltage stored in the first capacitor C1 may be output to the column line CL.

In a time period from T8 to T9, the third sampling control signal SPS3 may transition to the high level such that the third sampling transistor SPT3 is turned on. In this case, an output signal SIG_GS_AF corresponding to the voltage stored in the third capacitor C3 may be output to the column line CL.

In a time period from T9 to T10, the sampling control signal SPS2 may transition to the high level, and thus, the second sampling transistor SPT2 may be turned on. Accordingly, a first image signal SIG_GS_S corresponding to the voltage stored in the second capacitor C2 may be output to the column line CL.

The signals RST_GS, SIG_GS_AF, SIG_GS_S sequentially output to the column line CL in the readout period RD4 may be input to the ADC Circuit 160 of FIG. 1. The ADC Circuit 160 may generate a digital image signal by using the ramp signal RAMP, the first reset signal RST_GS, and the first image signal SIG_GS_S. Also, the ADC Circuit 160 may generate an autofocus signal by using the output signal SIG_GS_AF and the first image signal SIG_GS_S.

An image sensor including a pixel array composed of the image pixels 600 may generate an image signal together with autofocus information even in the GS mode.

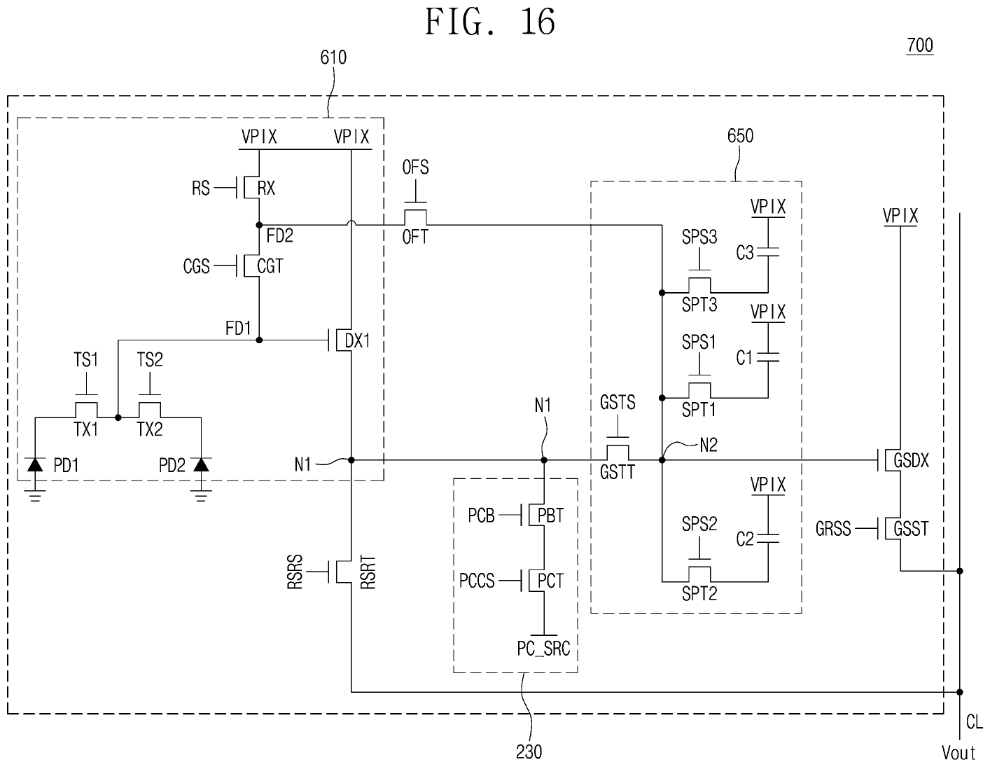

FIG. 16 is a circuit diagram of an image pixel according to an embodiment of the present disclosure.

Referring to FIGS. 13 and 16 together, an image pixel 700 includes the same configuration as the image pixel 600 of FIG. 13 except that the overflow transistor OFT is electrically connected to the second node N2, not directly connected to the first terminal of the third capacitor C3, and thus, additional description will be omitted to avoid redundancy.

When the image pixel 700 operates in the RS mode, in an exposure period, the overflow transistor OFT may be turned on in response to the overflow signal OFS of the high level. In this case, the sampling transistors SPT1, SPT2, and SPT3 may be respectively controlled by the sampling control signals SPS1, SPS2, and SPS3. In the exposure period, the charges that overflow from the first and second photodiodes PD1 and PD2 may be stored by using a combination of the first to third capacitors C1, C2, and C3. Afterwards, in a readout period, an image signal corresponding to the combination may be generated. That is, depending on a dynamic range to be implemented in the RS mode, the image pixel 700 may selectively store the overflowed charges in a capacitor selected from the first to third capacitors C1, C2, and C3.

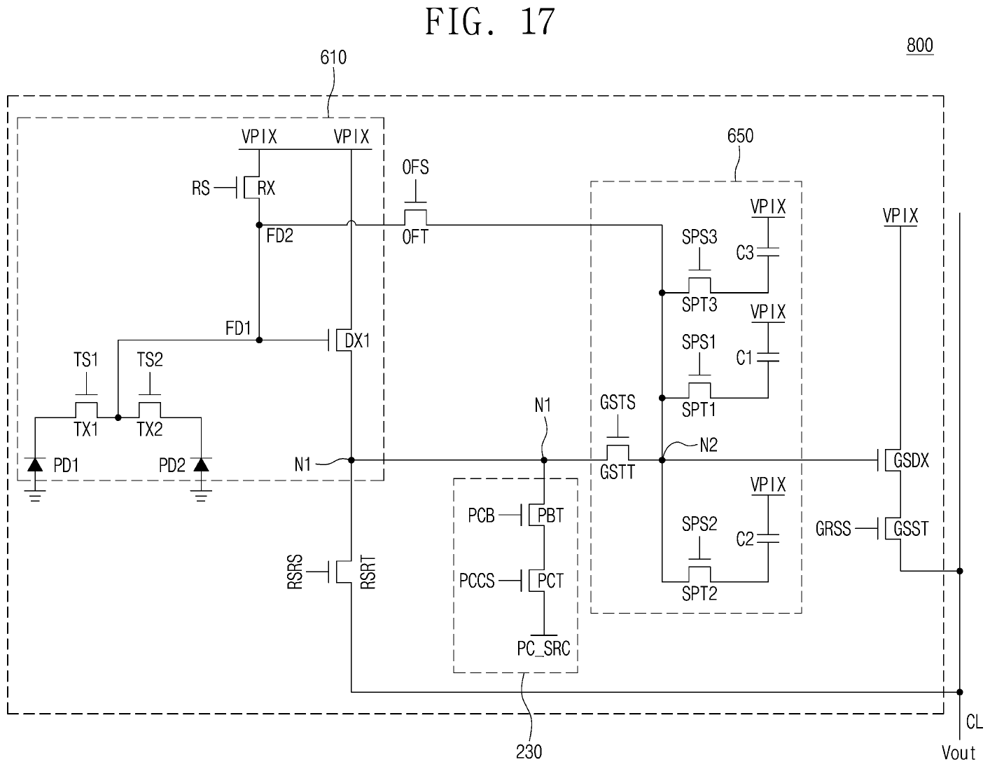

FIG. 17 is a circuit diagram of an image pixel according to an embodiment of the present disclosure.

Referring to FIGS. 16 and 17 together, an image pixel 800 includes the same configuration as the image pixel 700 of FIG. 16 except that the conversion gain transistor CGT is not included in the common circuit 610, and thus, additional description associated with the same components and operations will be omitted to avoid redundancy.

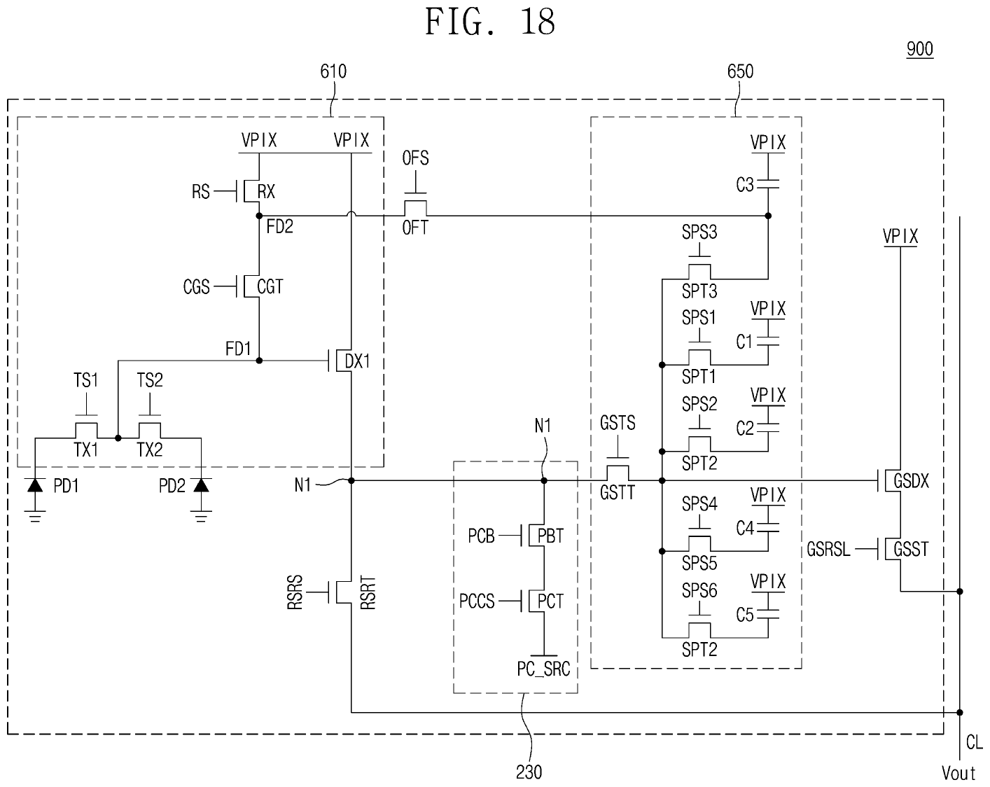

FIG. 18 is a circuit diagram of an image pixel according to an embodiment of the present disclosure.

Referring to FIGS. 13 and 18 together, an image pixel 900 of FIG. 18 includes the same configuration as the image pixel 600 of FIG. 13 except that the sampling circuit 650 further includes the fourth capacitor C4, the fifth capacitor C5, a fourth sampling transistor SPT4, and a fifth sampling transistor SPT5.

To obtain an image of a high dynamic range even in the GS mode, the image pixel 900 may generate an image signal using the high conversion gain and an image signal using the low conversion gain by controlling the conversion gain transistor CGT. In the sampling period of the GS mode, a reset voltage and an image voltage that are generated by using the high conversion gain, with the conversion gain transistor CGT turned off, are respectively stored in the first capacitor C1 and the second capacitor C2, and a reset voltage and an image voltage that are generated by using the low conversion gain, with the conversion gain transistor CGT turned on, are respectively stored in the fourth capacitor C4 and the fifth capacitor C5. Also, in the sampling period of the GS mode, a signal associated with autofocus information is stored in the third capacitor C3.

An image sensor including a pixel array composed of the image pixels 900 may generate an autofocus signal and an image signal of a high dynamic range together in both the RS mode and the GS mode.

An operation of the image pixel 900 in the RS mode may be the same as that described with reference to the timing diagram of FIG. 13.

FIG. 19 is a timing diagram that illustrates an operation of an image pixel of FIG. 18 in a GS mode.

Referring to FIGS. 15 and 19 together, the timing diagram of FIG. 19 further includes fourth and fifth sampling control signals SPS4 and SPS5, compared to the timing diagram of FIG. 15. Thus, additional description associated with the same operations will be omitted to avoid redundancy.

In a reset period RS5, the first floating diffusion node FD1, the second floating diffusion node FD2, and the first to fifth capacitors C1,C2, C3, C4, and C5 may be reset together.

A sampling period SMP3 may include a time period from T2 to T6.

In a time period from T1 to T2, the conversion gain transistor CGT may be turned on in response to the conversion gain signal CGS of the high level. In a state where the conversion gain transistor CGT is turned on, the sampling control signal SPS1 may transition to the high level such that the first sampling transistor SPT1 is turned on. In this case, a voltage converted by using the low conversion gain corresponding to the reset floating diffusion nodes FD1 and the FD2 may be stored in the first capacitor C1.

In a time period from T2 to T3, the conversion gain transistor CGT may be turned off in response to the conversion gain signal CGS of the low level. In a state where the conversion gain transistor CGT is turned off, the sampling control signal SPS4 may transition to the high level such that the fourth sampling transistor SPT4 is turned on. In this case, a voltage converted by using the high conversion gain corresponding to the reset floating diffusion node FD1 may be stored in the fourth capacitor C4.

In a time period from T3 to T4, as the transfer control signal TS1 transitions to the high level, the charges accumulated by the first photodiode PD1 may be transferred to the first floating diffusion node FD1. Also, the third sampling signal SPS3 may transition to the high level such that the third sampling transistor SPT3 is turned on. In this case, a voltage converted by using the high conversion gain corresponding to the first floating diffusion node FD1 may be stored in the third capacitor C3.

In a time period from T4 to T5, the second transfer control signal TS2 and the first transfer control signal TS1 may transition to the high level. In this case, charges generated by the second photodiode PD2 and the charges generated by the first photodiode PD1 may be stored at the first floating diffusion node FD1. Afterwards, as the sampling control signal SPS2 transitions to the high level, the second sampling transistor SPT2 may be turned on, and thus, a voltage that corresponds to a sum of the charges transferred from the first and second photodiodes PD1 and PD2 to the first floating diffusion node FD1 and is converted by using the high conversion gain corresponding to the first floating diffusion node FD1 may be stored in the second capacitor C2.

In a time period from T5 to T6, the conversion gain transistor CGT may be turned on in response to the conversion gain signal CGS of the high level. In this case, the charges of the first floating diffusion node FD1 may be shared with the second floating diffusion node FD2. Afterwards, the sampling control signal SPS5 may transition to the high level, and thus, the fifth sampling transistor SPT5 may be turned on. In this case, a voltage that corresponds to a sum of the charges transferred from the first and second photodiodes PD1 and PD2 to the first floating diffusion node FD1 and FD1 and is converted by using the low conversion gain corresponding to the first and second floating diffusion nodes FD1 and FD2 may be stored in the fifth capacitor C5.

In a readout period RD5, after the first and second nodes N1 and N2 are reset, output signals corresponding to the voltages stored in the first to fifth capacitors C1 to C5 may be sequentially output to the column line CL.

For example, a second reset signal RST_GS_L of the low conversion gain corresponding to the voltage stored in the first capacitor C1, a first reset signal RST_GS_H of the high conversion gain corresponding to the voltage stored in the fourth capacitor C4, an output signal SIG_GS_AF of the high conversion gain corresponding to the voltage stored in the third capacitor C3, a first image signal SIG_GS_SH of the high conversion gain corresponding to the voltage stored in the second capacitor C2, and a second image signal SIG_GS_SL of the low conversion gain corresponding to the voltage stored in the fifth capacitor C5 may be sequentially output. While the output signals RST_GS_L, RST_GS_H, SIG_GS_AF, SIG_GS_SH, and SIG_GS_SL are sequentially output to the column line CL, the GS transfer signal GSTS, the precharge control signal PCCS, and the precharge bias signal PCB may toggle to reset the first node N1 and the second node N2.

The signals RST_GS_L, RST_GS_H, SIG_GS_AF, SIG_GS_SH, and SIG_GS_SL output to the column line CL in the readout period RD5 may be input to the ADC Circuit 160 of FIG. 1, and the ADC Circuit 160 may generate a first digital image signal of the low conversion gain by using the ramp signal RAMP, the second reset signal RST_GS_L, and the second image signal SIG_GS_SL, may generate a second digital image signal of the high conversion gain by using the first reset signal RST_GS_H and the first image signal SIG_GS_SH, and may generate an autofocus signal by using the output signal SIG_GS_AF and the first image signal SIG_GS_SH. Afterwards, the data buffer 170 and the signal processor 190 may generate a final image signal by using the first and second digital image signals.

An image sensor including a pixel array composed of the image pixels 900 may generate an image signal of a high dynamic range together with autofocus information in both the RS mode and the GS mode.

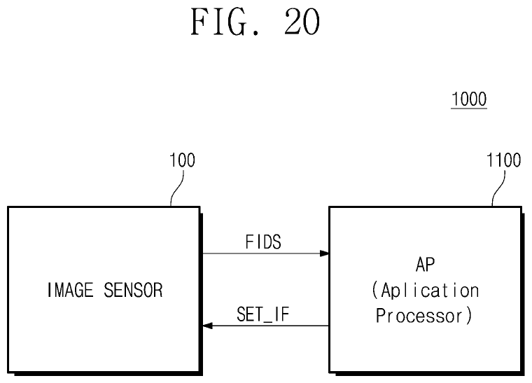

FIG. 20 is a block diagram illustrating an electronic device in which an image sensor including a pixel array composed of image pixels according to embodiments of the present disclosure is included.

Referring to FIG. 20, an electronic device 1000 may include the image sensor 100 and an application processor 1100. The application processor 1100 may transmit setting control signals SET_IF for controlling an operation of the image sensor 100 to the image sensor 100 through a given interface. The transmission of the setting control signals SET_IF may be performed, for example, based on the I2C-based interface (I squared C-based interface) for each frame. The setting control signals SET_IF may include, for example, setting information for setting an operating mode, a conversion gain, etc. of the image sensor 100. The operating mode may include the rolling shutter mode and the global shutter mode. The conversion gain may be set to support one of at least two different conversion gains or all the conversion gains.

The image sensor 100 may include a pixel array that is implemented by using one of the image pixels PX and 200 to 900 described with reference to FIGS. 3 to 19. The image sensor 100 may store information about the operating mode in the mode setting register 120 of FIG. 1 based on the setting control signals SET_IF of the application processor 1100 and may generate a final image by photographing a subject based on the operating mode.

An image pixel included in the image sensor 100 may operate in the global shutter mode or the rolling shutter mode deepening on the operating mode whose information is stored in the mode setting register 120. The image pixel may operate in a high conversion gain mode, a low conversion gain mode, or a dual conversion gain mode for each operating mode. Also, the image pixel may generate an autofocus signal in all the operating modes.

The image sensor 100 may transmit final image data FIDS and an autofocus signal to the application processor 1100. The application processor 1100 may perform one or more of the following image processing operations with respect to the received final image data FIDS: bad pixel correction, autofocus correction, auto-white balance, auto-exposure, noise reduction, sharpening, gamma control, remosaic, demosaic, and resolution scaling (video/preview).

Image pixels of the present disclosure may selectively operate in one of the rolling shutter mode and the global shutter mode. Each image pixel may generate an image signal of a high dynamic range by storing overflowed charges in at least one of the capacitors used in the global shutter mode when each image pixel operates in the rolling shutter mode.

According to the present disclosure, an image pixel may selectively operate in a rolling shutter mode and a global shutter mode and may generate an image signal of a high dynamic range.

While the present disclosure has been described with reference to embodiments thereof, it will be apparent to those of ordinary skill in the art that various changes and modifications may be made thereto without departing from the spirit and scope of the present disclosure as set forth in the following claims.

1. An image pixel comprising:
a photoelectric conversion element;
a common circuit including a floating diffusion node configured to receive charges from the photoelectric conversion element, and configured to transfer an output voltage to a first node based on a voltage of the floating diffusion node;
a sampling circuit including a first capacitor and a second capacitor configured to store the output voltage of the first node; and
a first transistor configured to electrically connect at least one of the first or second capacitors to the floating diffusion node.

2. The image pixel of claim 1, further comprising:
a second transistor connected between the first node and a column line,
wherein, in a first operating mode, the second transistor is configured to transfer the output voltage of the first node to the column line.

3. The image pixel of claim 2, further comprising:
a precharge circuit connected to the first node,
wherein the sampling circuit further includes:
a third transistor electrically connected between the first node and a second node;
a fourth transistor electrically connected between the second node and the first capacitor; and
a fifth transistor electrically connected between the second node and the second capacitor.

4. The image pixel of claim 3, further comprising:
a sixth transistor electrically connected between the second node and the column line,
wherein, in a second operating mode, the sixth transistor is configured to transfer an output signal to the column line in response to a voltage of the second node.

5. The image pixel of claim 4, wherein the common circuit further includes:
a transfer transistor electrically connected between the floating diffusion node and a photodiode;
a reset transistor configured to reset the floating diffusion node; and
a drive transistor configured to generate the output voltage of the first node in response to the voltage of the floating diffusion node,
wherein the photoelectric conversion element, the common circuit, and the second transistor are formed in a first semiconductor substrate, and
wherein the first transistor, the precharge circuit, the sampling circuit, and the sixth transistor are formed in a second semiconductor substrate stacked on the first semiconductor substrate.

6. The image pixel of claim 4, wherein the common circuit further includes:
a transfer transistor electrically connected between the floating diffusion node and a photodiode;
a reset transistor configured to reset the floating diffusion node; and
a drive transistor configured to generate the output voltage of the first node in response to the voltage of the floating diffusion node,
wherein the photoelectric conversion element, the common circuit, and the first and second transistors are formed in a first semiconductor substrate, and
wherein the precharge circuit, the sampling circuit, and the sixth transistor are formed in a second semiconductor substrate stacked on the first semiconductor substrate.

7. The image pixel of claim 4, wherein the first transistor is electrically connected between the floating diffusion node and a first terminal of the first capacitor, and a second terminal of the first capacitor is electrically connected to a pixel voltage,
wherein, in the second operating mode,
the first capacitor is configured to store the output voltage of the first node when the floating diffusion node is in a reset state, and
the second capacitor is configured to store the output voltage of the first node when charges are transferred from the photoelectric conversion element to the floating diffusion node.

8. The image pixel of claim 7, wherein a capacitance of the first capacitor is less than a capacitance of the second capacitor.

9. The image pixel of claim 8, wherein, in the first operating mode, the first capacitor is configured to store charges overflowed from the photoelectric conversion element.

10. The image pixel of claim 4, wherein the first transistor is electrically connected between the floating diffusion node and the second node.

11. An image pixel comprising:
a first photodiode;
a common circuit including:
a first transfer transistor configured to transfer charges generated by the first photodiode to a first floating diffusion node;
a reset transistor and a conversion gain transistor electrically connected in series between a pixel voltage and the first floating diffusion node and configured to share a second floating diffusion node; and
a drive transistor configured to generate an output voltage at a first node in response to a voltage of the first floating diffusion node;
a sampling circuit including a first capacitor and a second capacitor configured to store the output voltage of the first node; and
a first transistor configured to electrically connect at least one of the first or second capacitors to the second floating diffusion node.

12. The image pixel of claim 11, further comprising:
a second transistor connected between the first node and a column line,
wherein, in a first operating mode, the second transistor is configured to transfer the output voltage of the first node to the column line.

13. The image pixel of claim 12, further comprising:
a precharge circuit electrically connected to the first node,
wherein the sampling circuit further includes:
a third transistor electrically connected between the first node and a second node;
a fourth transistor electrically connected between the second node and the first capacitor; and
a fifth transistor electrically connected between the second node and the second capacitor.

14. The image pixel of claim 13, further comprising:
a sixth transistor electrically connected between the second node and the column line,
wherein, in a second operating mode, the sixth transistor is configured to transfer an output signal to the column line in response to a voltage of the second node.

15. The image pixel of claim 14, wherein a photoelectric conversion element, the common circuit, and the second transistor are formed in a first semiconductor substrate, and
wherein the first transistor, the precharge circuit, the sampling circuit, and the sixth transistor are formed in a second semiconductor substrate stacked on the first semiconductor substrate.

16. The image pixel of claim 13, wherein the first transistor is electrically connected between the second floating diffusion node and a first terminal of the first capacitor, and a second terminal of the first capacitor is electrically connected to the pixel voltage.

17. The image pixel of claim 14, further comprising:
a second photodiode,
wherein the common circuit further includes:
a second transfer transistor configured to transfer charges of the second photodiode to the first floating diffusion node,
wherein the sampling circuit further includes:
a third capacitor configured to store the output voltage of the first node; and
a seventh transistor configured to electrically connect the second node and the third capacitor, and
wherein the first transistor is configured to connect at least one of the first, second, or third capacitors to the second floating diffusion node.

18-22. (canceled)

23. An image sensor comprising:
a pixel array in which a plurality of image pixels are arranged; and
a mode setting register configured to set an operating mode of the image sensor including the pixel array,
wherein each of the plurality of image pixels includes:
a photodiode;
a common circuit including a floating diffusion node configured to receive charges from the photodiode and configured to transfer an output voltage of a first node based on a voltage of the floating diffusion node;
a first transistor electrically connected between the first node and a column line;
a sampling circuit including a second transistor electrically connected between the first node and a second node, a first capacitor, and a second capacitor, wherein the first and second capacitors are electrically connected to the second node;
a third transistor electrically connected between the second node and the column line; and
a fourth transistor configured to electrically connect the floating diffusion node and the first capacitor, and
wherein, when the operating mode is a rolling shutter mode, the fourth transistor is configured to transfer charges that overflow from the photodiode to the first capacitor for storage therein.

24. The image sensor of claim 23, wherein, when the operating mode is the rolling shutter mode, an output voltage of the first node, which corresponds to an amount of the charges stored in the first capacitor, and an output voltage of the first node, which corresponds to the amount of the charges accumulated by the photodiode, are output to the column line.

25. The image sensor of claim 23, wherein, when the operating mode is a global shutter mode, an output voltage of the first node, which corresponds to a reset state of the floating diffusion node, is stored in the first capacitor, and an output voltage of the first node, which corresponds to a state where the charges accumulated by the photodiode are transferred to the floating diffusion node, is stored in the second capacitor.

26-29. (canceled)
